(19) United States
(12) Patent Application Publication
(10) Pub. No.: US 2026/0222724 A1
(43) Pub. Date: Jul. 30, 2026

(54) CLIP-ON EARPHONES

(71) Applicant: SHENZHEN SHOKZ CO., LTD., Shenzhen (CN)

(72) Inventors: Lei ZHANG, Shenzhen (CN); Chaojie CUI, Shenzhen (CN); Lei ZHONG, Shenzhen (CN); Jiang XU, Shenzhen (CN); Haochen LIU, Shenzhen (CN); Xin QI, Shenzhen (CN)

(73) Assignee: SHENZHEN SHOKZ CO., LTD., Shenzhen (CN)

(21) Appl. No.: 19/574,209

(22) Filed: Mar. 20, 2026

Related U.S. Application Data
(63) Continuation of application No. PCT/CN2024/138263, filed on Dec. 10, 2024.

(30) Foreign Application Priority Data
Dec. 11, 2023 (CN) 202311701969.7

(51) Int. Cl. H04R 1/10

(52) U.S. Cl. CPC H04R 1/105; H04R 1/1016

(57) ABSTRACT

A clip-on earphone includes a sound production portion for inserting into a concha cavity of a wearer, an abutment portion for abutting against a back of an ear of the wearer, and an ear hook connecting the sound production portion and the abutment portion. The abutment portion includes a first rigid housing, a second rigid housing, and a first flexible member covering an outer wall of the second rigid housing. An outer wall of the first rigid housing is not covered by the first flexible member and is in an exposed state; or the first flexible member extends from an outer side of the second rigid housing to an outer side of the first rigid housing and covers a portion of the outer wall of the first rigid housing, such that a remaining portion of the outer wall of the first rigid housing is in an exposed state.

### CROSS-REFERENCE TO RELATED APPLICATIONS

This application is a Continuation of International Application No. PCT/CN2024/138263, filed on Dec. 10, 2024, which claims priority to Chinese Patent Application No. 202311701969.7, filed Dec. 11, 2023, the entire contents of which are hereby incorporated by reference.

### TECHNICAL FIELD

The present disclosure relates to the field of sound production apparatus, and in particular, to a clip-on earphone.

### BACKGROUND

Earphones are widely used in people's daily lives. The earphones may be used in conjunction with electronic devices, such as cellular phones and computers, to facilitate auditory functions for users. A clip-on earphone is a new type of earphone that is typically small enough to be used by clamping them near a helix of a wearer, providing more comfortable wearing.

A housing of the clip-on earphone may be made of a rigid material or a flexible material. A housing made of the rigid material is insufficient in comfort, and the flexible material is poor in support for an internal structure. Therefore, how to balance comfort and support is a problem that needs to be further optimized for current clip-on earphones.

### SUMMARY

The present disclosure provides a clip-on earphone to demonstrate a structure that can balance comfort and support.

One or more embodiments of the present disclosure provide a clip-on earphone. The earphone includes a sound production portion for inserting into a concha cavity of a wearer; an abutment portion for abutting against a back of an ear of the wearer; and an ear hook connecting the sound production portion and the abutment portion. The abutment portion and the sound production portion form a clamping state to clamp and wear the clip-on earphone on a helix of the wearer. The abutment portion includes a first rigid housing and a second rigid housing arranged toward the back of the ear of the wearer when worn, the second rigid housing and the first rigid housing enclose to form a first accommodating cavity. The abutment portion also includes a first flexible member covering an outer wall of the second rigid housing for contacting the back of the ear of the wearer. An outer wall of the first rigid housing is not covered by the first flexible member and is in an exposed state; or the first flexible member extends from an outer side of the second rigid housing to an outer side of the first rigid housing and covers a portion of the outer wall of the first rigid housing, such that a remaining portion of the outer wall of the first rigid housing is in an exposed state.

According to the clip-on earphone of the above embodiment, the earphone includes the sound production portion, the abutment portion, and the ear hook connected to the sound production portion and the abutment portion. The abutment portion includes the first rigid housing, the second rigid housing, and the first flexible member. The first rigid housing and the second rigid housing enclose to form the first accommodating cavity. The first rigid housing and the second rigid housing can provide better support to support the internal structure. Typically, the second rigid housing is arranged toward the back of the ear of the wearer when the clip-on earphone is worn. In this embodiment, the first flexible member covers the outer wall of the second rigid housing, which can reduce the possibility of direct contact between the second rigid housing and the skin of the wearer, thereby improving wearing comfort of the earphone. Meanwhile, in the abutment portion, the first flexible member mainly covers the second rigid housing, which basically does not affect external structures and an internal space of the first rigid housing, thereby ensuring utilization of the internal space of the first rigid housing.

### BRIEF DESCRIPTION OF THE DRAWINGS

FIG. 1 is a schematic diagram of an external structure of a clip-on earphone according to an embodiment of the present disclosure.

FIG. 2 is a cross-sectional view along a length direction of an ear hook according to an embodiment of the present disclosure.

FIG. 3 is a cross-sectional view of a sound generation portion according to an embodiment of the present disclosure, wherein the sound generation portion has two loudspeakers.

FIGS. 4-7 are schematic diagrams of junctions of a first rigid housing, a second rigid housing, and a first flexible member according to several different embodiments of the present disclosure, which may also serve as schematic diagrams of junction surfaces of a third rigid housing, a fourth rigid housing, and a second flexible member.

FIGS. 8-12 are cross-sectional views of the sound generation portion according to several different embodiments of the present disclosure.

FIG. 13 is a cross-sectional view of a sound generation portion having one loudspeaker according to an embodiment of the present disclosure.

FIG. 14 is a cross-sectional view of the sound generation portion from another perspective according to an embodiment of the present disclosure.

FIG. 15 is a cross-sectional view along the length direction of the ear hook according to an embodiment of the present disclosure.

FIG. 16 are cross-sectional views of the third rigid housing, the fourth rigid housing, and the second flexible member according to several different embodiments of the present disclosure.

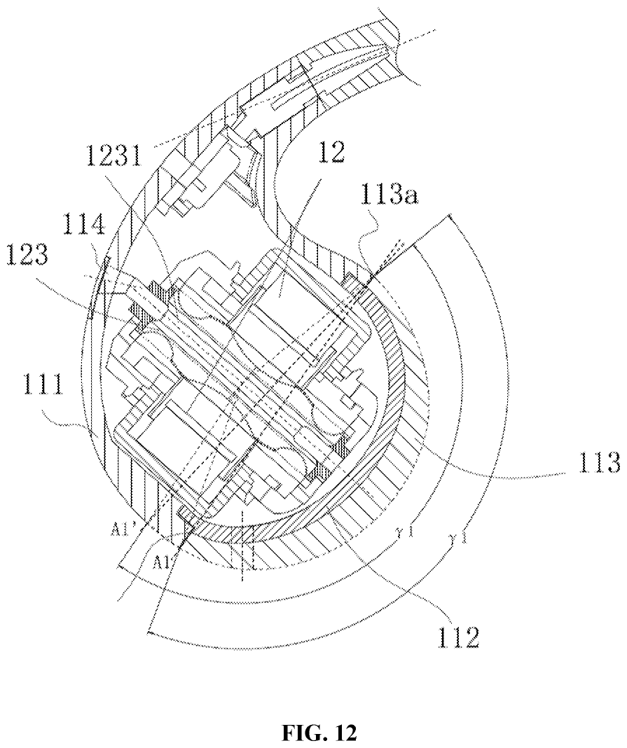

FIG. 17 is an exploded view of an abutting portion according to an embodiment of the present disclosure.

FIG. 18 is an exploded view of the abutting portion according to another embodiment of the present disclosure.

FIG. 19 is a cross-sectional view along the length direction of the ear hook according to another embodiment of the present disclosure.

FIG. 20 is a schematic perspective structural diagram of an earphone according to another embodiment of the present disclosure.

FIG. 21 is a cross-sectional view along the length direction of the ear hook according to another embodiment of the present disclosure.

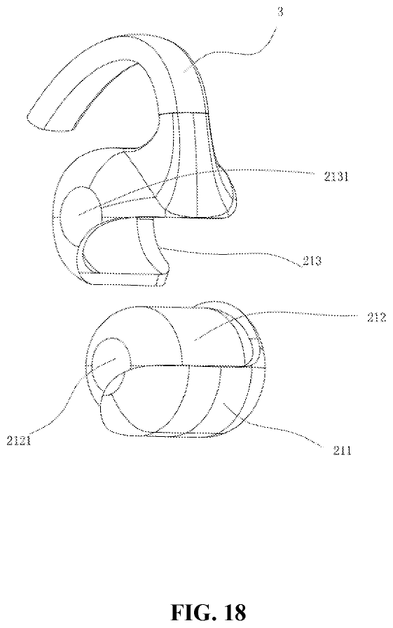

FIG. 22 is a cross-sectional view of the sound generation portion according to another embodiment of the present disclosure.

FIG. 23 are schematic diagrams illustrating a setting position of a sound outlet hole and a wearing state according to the present disclosure.

FIG. 24 are schematic diagrams illustrating wearing states under different β angles according to the present disclosure.

FIG. 25 is a reference plane for human body measurement according to the present disclosure.

FIG. 26 is a frequency response curve diagram at an ear canal opening corresponding to different β angles when α is 0 according to the present disclosure.

FIG. 27 is a frequency response curve diagram at the ear canal opening corresponding to different α angles when β is 0 according to the present disclosure.

FIG. 28 are schematic diagrams illustrating wearing states under different γ angles when the sound outlet hole is laterally disposed according to the present disclosure.

FIG. 29-A is a frequency response curve diagram at the ear canal opening corresponding to different γ angle setting gradients according to the present disclosure.

FIG. 29-B is a partial enlarged view of a curve in FIG. 29-A according to the present disclosure.

FIG. 30-A is a schematic diagram of a sound field of a “free field” in a “horn effect” according to the present disclosure.

FIG. 30-B is a schematic diagram of a sound field of a “reflection field” in the “horn effect” according to the present disclosure.

FIG. 31-A are diagrams of equal sound pressure level lines under different values of θ and h-gap according to the present disclosure.

FIG. 31-B are diagrams of equal sound pressure level lines under different values of θ and h-gap according to the present disclosure.

FIG. 31-C are diagrams of equal sound pressure level lines under different values of θ and h-gap according to the present disclosure.

FIG. 32 is a sound leakage curve under different setting positions of the sound outlet hole.

### DETAILED DESCRIPTION

The present disclosure is further described in detail below through specific embodiments in conjunction with the accompanying drawings. Similar element numbers are used for similar elements in different embodiments. In the following embodiments, many details are described to facilitate better understanding of the present disclosure. However, those skilled in the art can readily recognize that some features may be omitted under different circumstances, or may be replaced by other elements, materials, or methods. In some cases, some operations related to the present disclosure are not shown or described in the specification. This is done to avoid obscuring the core parts of the present disclosure with excessive description. For those skilled in the art, detailed description of these related operations is not necessary. Therefore, they can fully understand the related operations based on the description in the specification and general technical knowledge in the art.

In addition, the features, operations, or characteristics described in the specification may be combined in any appropriate manner to form various embodiments. Meanwhile, the steps or actions in the method description may also be reordered or adjusted in a manner obvious to those skilled in the art. Therefore, the various sequences in the specification and drawings are merely for clearly describing a particular embodiment. These sequences do not imply that they must be followed, unless otherwise stated that a particular sequence must be followed.

The numbering of components herein, such as “first,” “second,” etc., is only used to distinguish the described objects and has no sequential or technical meaning. The terms “connect” and “couple” as used in the present disclosure, unless otherwise specified, include both direct and indirect connection (coupling).

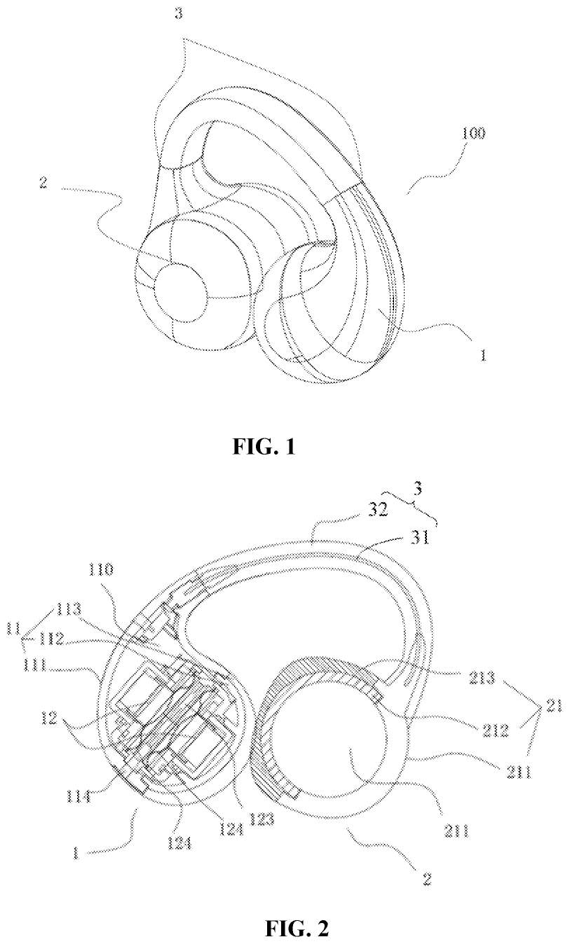

As shown in FIG. 1, the present disclosure provides a clip-on earphone 100. The earphone includes the following components: a sound production portion 1 for inserting into a concha cavity of a wearer; an abutment portion 2 for abutting against a back of an ear of the wearer; and an ear hook 3 connecting the sound production portion 1 and the abutment portion 2. The sound production portion 1 is a sound playback device configured to convert an electrical signal into a sound signal and play the sound signal to the wearer. The abutment portion 2 and the sound production portion 1 form a clamping state to clamp and wear the entire earphone on a helix of a user. For example, the sound production portion 1 may abut against an inner wall of the concha cavity, and the abutment portion 2 may abut against the back of the ear. This design allows the earphone to bypass the helix, thereby clamping and wearing on the ear of the user. In some embodiments, the abutment portion 2 may serve as a battery cavity for mounting a battery or other components. The abutment portion 2 may not serve as the battery cavity, and the battery may be mounted in the sound production portion 1.

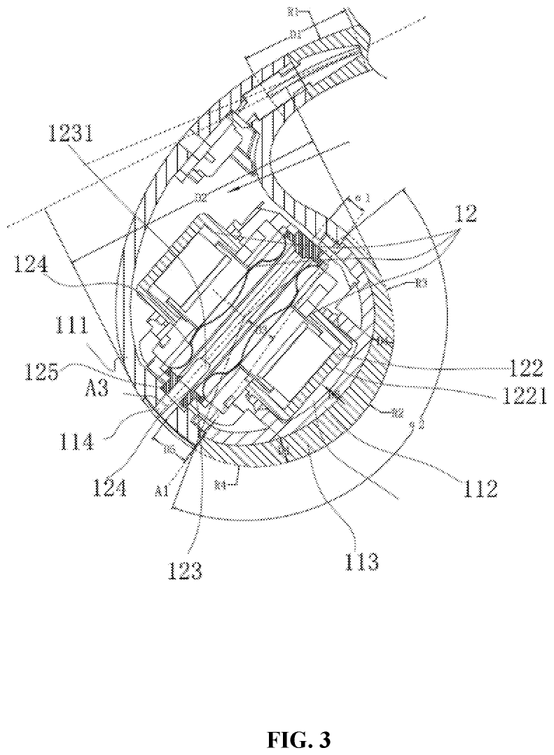

In some embodiments, as shown in FIG. 2, the sound production portion 1 includes a second housing 11 and a sound production assembly 12. The sound production assembly 12 is a module that can convert an electrical signal into a sound signal, and the sound production assembly 12 is typically a speaker. A count of the speaker in the sound production assembly 12 may be one or more than two.

As shown in FIG. 2, the second housing 11 includes a third rigid housing 111 configured to be connected to the ear hook 3, a fourth rigid housing 112 configured to face toward the concha cavity of the wearer when worn, and a third flexible member 113 configured to contact the concha cavity of the wearer. A rigid material may be plastic, metal, or any other support material that can be used as an earphone housing. These support materials are used to provide better support and stability for an internal structure of the second housing 11, and the internal structure includes the sound production assembly 12. The third rigid housing 111 and the fourth rigid housing 112 enclose to form a second accommodating cavity 110, and the sound production assembly 12 is disposed in the second accommodating cavity 110. The second housing 11 includes a sound outlet hole 114, and a sound wave generated by the sound production assembly 12 may propagate to the wearer through the sound outlet hole 114. The third flexible member 113 covers an outer wall of the fourth rigid housing 112. The third flexible member 113 may be made of silicone or other skin-friendly flexible materials, which can improve comfort when the sound production portion 1 contacts the wearer.

The third rigid housing 111 and the fourth rigid housing 112 can provide better support for the internal structures. Usually, the fourth rigid housing 112 faces the concha cavity of the wearer when worn. In this embodiment, the third flexible member 113 covers the outer wall of the fourth rigid housing 112 to reduce the possibility of the fourth rigid housing 112 directly contacting the skin of the wearer, and improve comfort of wearing the earphone.

Meanwhile, in the second housing 11, the third flexible member 113 mainly covers the fourth rigid housing 112, basically does not affect an external structure and an internal space of the third rigid housing 111, and ensures utilization of the internal space of the third rigid housing 111. Specifically, the third flexible member 113 is coated on the outer wall of the fourth rigid housing 112. Therefore, a part of the fourth rigid housing 112 has a double-layer wall thickness. An outer wall of the third rigid housing 111 is not coated with the third flexible member 113 and is in an exposed state. Alternatively, the third flexible member 113 extends from an outer side of the fourth rigid housing 112 to an outer side of the third rigid housing 111. Only a part of the third rigid housing 111 close to the fourth rigid housing 112 is covered by the third flexible member 113, and the remaining part of the third rigid housing 111 is in the exposed state. Therefore, the third rigid housing 111 only needs a single-layer wall thickness, so that the third rigid housing 111 occupies a small volume of the second accommodating cavity 110, leaving a large space for the sound generation assembly 12. Accordingly, a sound generation assembly 12 with a larger oscillator can be placed to form a better acoustic effect.

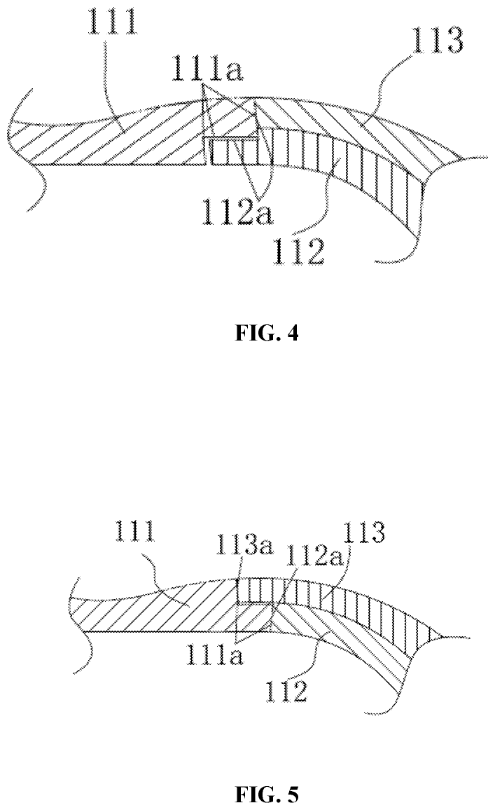

Referring to FIG. 2 and FIG. 3, in some embodiments, a plane where an outermost annular line of an end surface of the third flexible member 113 is located is a first reference plane A1. On a section perpendicular to the first reference plane A1 and passing through a center of the first reference plane A1 (the center of the first reference plane A1 refers to a center of the outermost annular line of the end surface of the third flexible member 113), a coverage area of the third flexible member 113 on the fourth rigid housing 112 is greater than or equal to 80% (e.g., 80%, 85%, 90%, 95%, or 100%) of a curve length segment of the fourth rigid housing 112 (here, the curve length segment of the fourth rigid housing 112 refers to an outer contour line of the fourth rigid housing 112), which ensures that the third flexible member 113 can cover a sufficiently large area on the fourth rigid housing 112 to reduce or eliminate the possibility of the wearer directly contacting the fourth rigid housing 112.

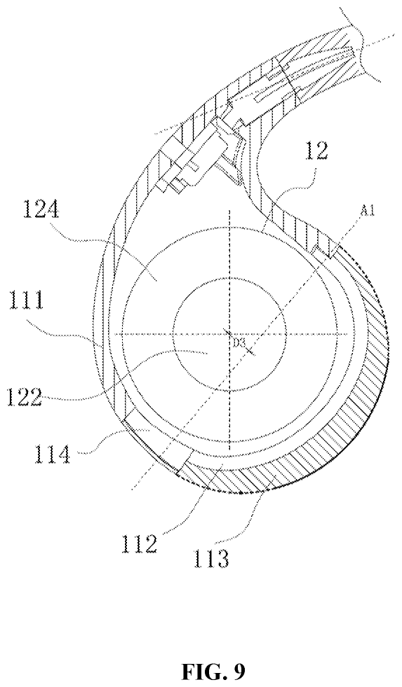

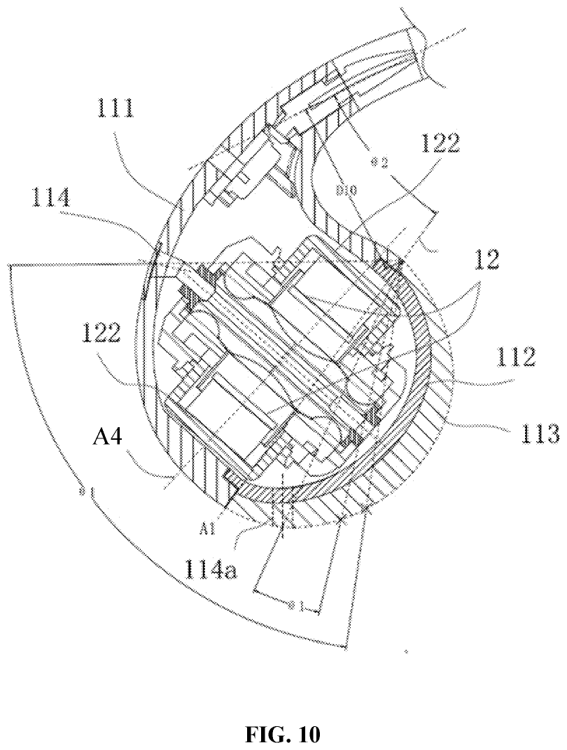

In some embodiments, referring to FIG. 2 and FIG. 13, an ear hook symmetry plane A2 (marked in FIG. 14) of the ear hook 3 has two intersection points with the outermost annular line of the end surface of the third flexible member 113. A section perpendicular to the ear hook symmetry plane A2 and passing through the two intersection points may also be used as the first reference plane A1. On a section perpendicular to the first reference plane A1 and passing through the center of the outermost annular line of the end surface of the third flexible member 113, the coverage area of the third flexible member 113 on the fourth rigid housing 112 is greater than or equal to 80% (e.g., 80%, 85%, 90%, 95%, or 100%) of the curve length segment of the fourth rigid housing 112 (here, the curve length segment of the fourth rigid housing 112 refers to the outer contour line of the fourth rigid housing 112). In this embodiment, a proportion of the third flexible member 113 on the fourth rigid housing 112 is defined from another perspective, so that the third flexible member 113 can cover a sufficiently large area on the fourth rigid housing 112 to reduce or eliminate the possibility of the wearer directly contacting the fourth rigid housing 112. The ear hook symmetry plane A2 refers to a plane where the ear hook 3 is symmetrical left and right along a length extension direction. When the ear hook 3 has an asymmetric structure of a special shape, a difference between the ear hooks 3 on both sides of the ear hook symmetry plane A2 should be the smallest among various division manners. For example, the ear hook symmetry plane A2 may be determined by a center of the first reference plane A1 (the center of the first reference plane A1 refers to the center of the outermost annular line of the end surface of the third flexible member 113), a center of a section of the abutting portion 2 perpendicular to a length direction thereof (the length direction will be described later), and a center point of the length direction of the ear hook 3.

In some embodiments, referring to FIG. 3, on a first predetermined section, a coverage area of the third flexible member 113 on the fourth rigid housing 112 is greater than or equal to 80% (e.g., 80%, 85%, 90%, 95%, or 100%) of the curve length segment of the fourth rigid housing 112 (here, the curve length segment of the fourth rigid housing 112 refers to the outer contour line of the fourth rigid housing 112). In the description of the present disclosure, without special instructions, the “first predetermined section” refers to the section perpendicular to the first reference plane A1 and passing through the center of the outermost annular line of the end surface of the third flexible member 113 or refers to the ear hook symmetry plane A2. The “first reference plane A1” refers to a plane where the outermost annular line of the end surface of the third flexible member 113 is located. In addition, the ear hook symmetry plane A2 (marked in FIG. 14) intersects the outermost annular line of the end surface of the third flexible member 113 to form two intersection points. The “first reference plane A1” also refers to the section perpendicular to the ear hook symmetry plane A2 and passing through these two intersection points. In this way, the third flexible member 113 can cover a sufficiently large area on the fourth rigid housing 112 to reduce or eliminate the possibility of the wearer directly contacting the fourth rigid housing 112.

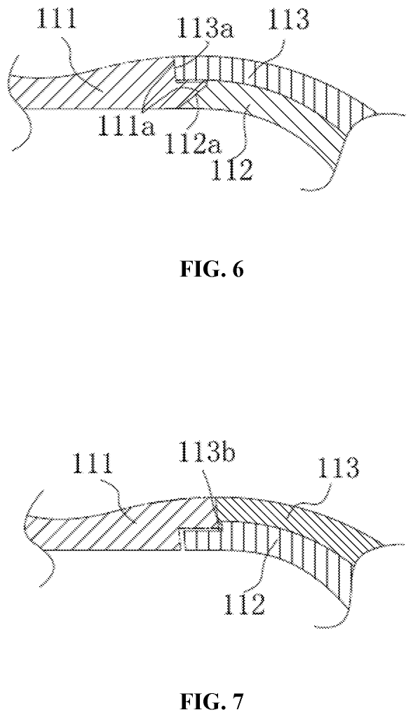

In some embodiments, referring to FIG. 4-FIG. 7, an end portion of the fourth rigid housing 112 is spliced and fixed to an end portion of the third rigid housing 111. The end portion of the fourth rigid housing 112 and the end portion of the third rigid housing 111 are fixed by splicing to form a reliable fixation with a small occupied size. This splicing manner is also convenient for assembly and reduces assembly processes.

Specifically, during production and processing of the earphone, to ensure a firmer connection between the third flexible member 113 (usually made of silicone material) and the fourth rigid housing 112, the third flexible member 113 needs to be injection-molded on the basis of the fourth rigid housing 112. If the third flexible member 113 has a relatively large length that spans a splicing position between the third rigid housing 111 and the fourth rigid housing 112, an injection molding process can be performed only after the loudspeaker is installed in the second housing and the splicing is completed. In this situation, internal components of the second housing will be damaged by high temperature during the injection molding process, which is not conducive to improving the yield of the product. Therefore, by setting most areas of the third flexible member 113 on the fourth rigid housing 112, silicone is injection-molded on the fourth rigid housing 112 first and then assembled, which not only simplifies the process but also avoids damage to the loudspeaker caused by injection molding after assembly.

In some embodiments, referring to FIG. 3, a portion of the outer wall of the fourth rigid housing 112 that is not shielded by the third rigid housing 111 is covered by the third flexible member 113. Since an area of the second housing 11 that contacts the wearer is typically concentrated on the fourth rigid housing 112, this structure ensures that the fourth rigid housing 112 has no exposed areas, and the wearer does not directly contact the fourth rigid housing 112, thereby improving wearing comfort.

In some embodiments, referring to FIGS. 5 and 6, the third flexible member 113 extends from an outer side of the fourth rigid housing 112 to an outer side of the third rigid housing 111 and covers a part of an outer wall of the third rigid housing 111. A seam between the third rigid housing 111 and the fourth rigid housing 112 is typically a stress concentration area. A part of the outer wall of the third rigid housing 111 is covered by the third flexible member 113, such that the third flexible member 113 is fixed to both the third rigid housing 111 and the fourth rigid housing 112, which increases the firmness of the connection between the third rigid housing 111 and the fourth rigid housing 112 and provides protection for the stress concentration area. In addition, the third flexible member 113 can cover a partial region of the third rigid housing 111 near the fourth rigid housing 112 to prevent the wearer from directly contacting the fourth rigid housing 112 when touching the partial region, thereby improving comfort. Moreover, the third flexible member 113 can cover the seam between the third rigid housing 111 and the fourth rigid housing 112, thereby improving the sealing and waterproofing effect.

In some embodiments, referring to FIGS. 4 and 7, the third flexible member 113 does not cover the outer wall of the third rigid housing 111, so that the third flexible member 113 does not compress the internal space of the third rigid housing 111, thereby ensuring that the third rigid housing 111 has a larger internal space.

In some embodiments, referring to FIG. 5, an end surface 113a of the third flexible member 113 extends to an end surface 111a of the third rigid housing 111, that is, the end surface 113a of the third flexible member 113 abuts against the end surface 111a of the third rigid housing 111. Due to the flexible deformation characteristics of the third flexible member 113, a good sealing and waterproofing effect can be formed with the end surface 111a of the third rigid housing 111.

In some embodiments, a gap exists between the end surface 113a of the third flexible member 113 and the end surface 111a of the third rigid housing 111, which provides deformation space for the third flexible member 113 when the third flexible member 113 undergoes micro-deformation under pressure.

In some embodiments, referring to FIG. 4, the end surface 113a of the third flexible member 113 is flush with an outermost annular line of the end surface 113a of the third flexible member 113 in an inner-outer direction. An inner side refers to a side of the second housing 11 where the second accommodating cavity 110 is located. An outer side refers to an outer side of the second housing 11 away from the second accommodating cavity 110.

In some embodiments, a gap exists between the end surface 111a of the third rigid housing 111 and an end surface 112a of the fourth rigid housing 112. A portion 113b of the third flexible member 113 extends into the gap and is clamped and fixed by the end surface 111a of the third rigid housing 111 and the end surface 112a of the fourth rigid housing 112. In this embodiment, the third flexible member 113 can be more firmly attached to the fourth rigid housing 112, which forms a more secure fit than a manner which relies solely on adhesion. Simultaneously, in addition to providing a more comfortable contact feeling, the third flexible member 113, through the clamping action of the third rigid housing 111 and the fourth rigid housing 112, can also form a better sealing and waterproofing effect.

In the above various embodiments, the end surface 111a of the third rigid housing 111 and the end surface 112a of the fourth rigid housing 112 are a pair of mutually matched planes which may be inclined surfaces, stepped surfaces, folded surfaces, wavy surfaces, or a combination of at least two thereof, to facilitate better splicing of the third rigid housing 111 and the fourth rigid housing 112 and ensure the sealing and waterproofing effect. The end surface of the third rigid housing 111 and the end surface of the fourth rigid housing 112 are mutually matched, facilitating adhesion and fixation of the contact surfaces. Further, through more complex contact surface designs, such as the stepped surfaces, the adhesion surface area can be increased, thereby enhancing firmness. Even further, by combining various end surface configurations, a multi-directional and more secure adhesion structure can be formed.

Further, in some embodiments, referring to FIG. 3, the sound generation assembly 12 is mounted on the fourth rigid housing 112, and an end of the sound generation assembly 12 facing the third rigid housing 111 protrudes from the fourth rigid housing 112. In this embodiment, the split structure of the third rigid housing 111 and the fourth rigid housing 112 is fully utilized. The sound generation assembly 12 is first mounted on the fourth rigid housing 112, and then the fourth rigid housing 112 along with the components thereon can be fixed to the third rigid housing 111, which can reduce processing difficulty and improve processing efficiency and yield.

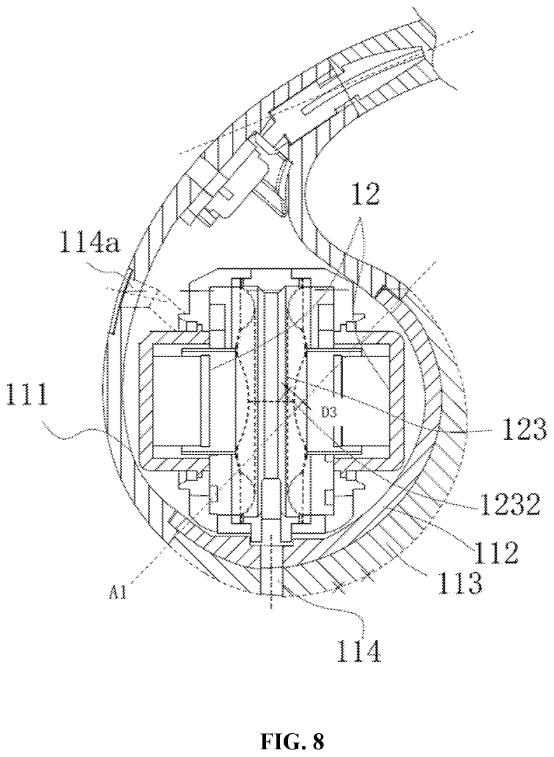

Further, the sound outlet hole 114 may be provided on the third rigid housing 111 (as shown in FIG. 3), or on the fourth rigid housing 112 and the third flexible member 113 (as shown in FIG. 8), or may be formed by combining the third rigid housing 111 and the fourth rigid housing 112 (as shown in FIG. 9).

In some embodiments, the sound outlet hole 114 is provided on a portion of the third rigid housing 111 that is not covered by the third flexible member 113. Thus, the sound outlet hole 114 does not need to penetrate both the third rigid housing 111 and the fourth rigid housing 112 simultaneously, avoiding unevenness on the surface of the sound outlet hole 114 which could affect the installation of a tuning mesh and a steel mesh. Furthermore, the sound outlet hole 114 being provided on the third rigid housing 111 eliminates the need to create a hole in the third flexible member 113 and eliminates the need to consider the influence of the third flexible member 113 on the sound outlet hole 114, which can reduce design and production costs.

In addition, since a larger internal accommodating space may be formed at the third rigid housing 111, a positioning boss may be provided at the sound outlet hole 114 on a diaphragm mounting bracket without excessively increasing the external dimension of the second housing 11, which increases the openness of the ear canal and improves the safety and comfort of the clip-on earphone.

In some embodiments, referring to FIG. 3, a central axis A3 of the sound outlet hole 114 forms an included angle α1 of 3°-9° with the first reference plane A1. For example, the included angle α1 may be 3°, 5°, 7°, or 9°. Such arrangement allows the sound outlet hole 114 not to span the two housings while being relatively close to the ear hole, increasing the sound volume.

In some embodiments, referring to FIG. 3, a distance D5 from an end of the sound outlet hole 114 close to the fourth rigid housing 112 to the first reference plane A1 is in a range of 1 mm-3 mm (e.g., 1 mm, 1.5 mm, 2 mm, 2.5 mm, or 3 mm). Such arrangement allows the sound outlet hole 114 not to span the two housings while being relatively close to the ear hole and provides space for an adhesive path between an acoustic mesh and the third rigid housing 111, and an adhesive path between the third rigid housing 111 and a mounting bracket 123 for a diaphragm of a loudspeaker.

In some embodiments, referring to FIG. 3, the third rigid housing 111 has a region facing the ear hole of the wearer when worn. The sound outlet hole 114 is at least partially located within the region, so that a sound propagation direction is oriented as much as possible toward the ear canal, which ensures that sound from the sound outlet hole 114 can enter the wearer's ear hole more promptly and accurately, achieving better sound listening effect and volume, and improving headphone sound quality.

In some embodiments, referring to FIG. 3, the sound generation assembly 12 includes a diaphragm 124. An outer edge mounting plane of the diaphragm 124 (as shown in FIG. 3, an edge of the diaphragm 124 abuts against the mounting bracket 123, and the outer edge mounting plane of the diaphragm 124 refers to a plane where the abutting position is located) and the first reference plane A1 forms an included angle of 3°-9°. For example, the included angle may be 3°, 5°, 7°, or 9°. Thus, the loudspeaker can be assembled with the third rigid housing 111 after the third rigid housing 111 and the fourth rigid housing 112 are assembled first. A single loudspeaker does not span a parting line between the third rigid housing 111 and the fourth rigid housing 112, facilitating assembly. Moreover, such arrangement allows the sound outlet hole 114 to face the ear hole while making a contact point between the concha cavity and the third flexible member 113 close to a center, which can adapt to a wider range of people and reduce the probability of the concha cavity contacting the rigid housing.

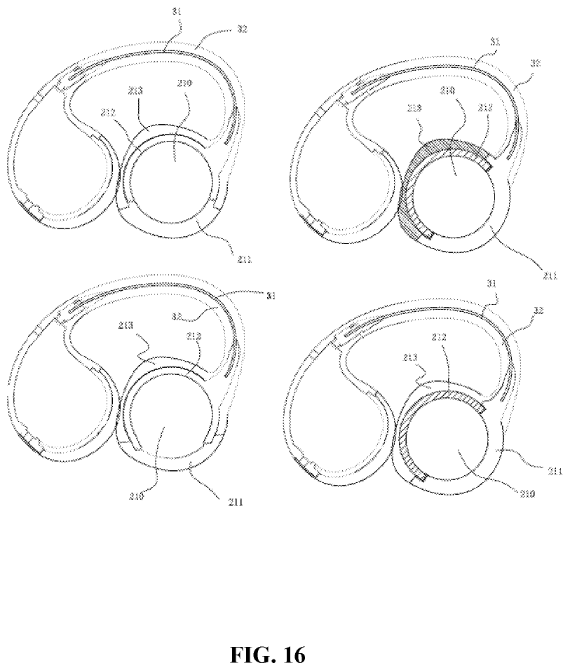

In some embodiments, referring to FIG. 19, the ear hook 3 has the ear hook symmetry plane A2 arranged along its length direction. The sound generation assembly 12 has the diaphragm 124. An included angle between the outer edge mounting plane of the diaphragm 124 and the ear hook symmetry plane A2 is less than 10°. According to such arrangement, a curve formed by cutting the second housing 11 by an outer ring of the loudspeaker and the concha cavity form a wedge-like space. When the sound outlet hole 114 is provided along the curve, the sound outlet hole 114 and the concha cavity may form a horn structure. Using the concha cavity as a reflective wall surface can create a horn effect, thereby increasing the sound volume.

The sound outlet hole 114 may be provided on the fourth rigid housing 112 and the third flexible member 113. In this way, the sound outlet hole 114 can be closer to the ear hole, which is beneficial for improving the listening effect. Moreover, the sound outlet hole 114 does not need to span both the third rigid housing 111 and the fourth rigid housing 112 simultaneously.

The sound outlet hole 114 may have a strip shape, and a length direction thereof is parallel or substantially parallel to the ear hook symmetry plane A2. The central axis A3 of the sound outlet hole 114 and the first reference plane A1 form an included angle α11 of 40°-80°. For example, α11 may be 40°, 50°, 60°, 70°, or 80°. In this way, the sound outlet hole 114 and the concha cavity may form a horn structure. Using the concha cavity as the reflective wall surface can create the horn effect, thereby increasing the sound volume. The term “parallel or substantially parallel to” described in the present disclosure means that the length direction of the sound outlet hole 114 is parallel to the ear hook symmetry plane A2, allowing an error within plus or minus 15°.

The sound outlet hole 114 has the strip shape, and the length direction thereof is parallel or substantially parallel to the ear hook symmetry plane A2. A distance from an end of the sound outlet hole 114 close to the third rigid housing 111 to the first reference plane A1 may be in a range of 1 mm-4 mm (e.g., 1 mm, 2 mm, 2.5 mm, 3 mm, or 4 mm). In this way, the sound outlet hole 114 can be relatively close to the ear hole, which is beneficial for enhancing the horn effect. In addition, it can also prevent the sound outlet hole 114 from spanning the two housings.

In some embodiments, referring to FIG. 3, a portion with the widest radius of the sound generation assembly 12 is located within the third rigid housing 111. Since the third rigid housing 111 is not provided with third flexible member 113 or only a part of the third rigid housing 111 is provided with the third flexible member 113, a space of the third rigid housing 111 is larger than a space of the fourth rigid housing 112. By placing the portion 125 with the widest radius of the sound generation assembly 12 inside the third rigid housing 111, a sound generation assembly 12 with a larger oscillator can be selected to obtain better sound quality. Compared with a manner where the portion 125 with the widest radius of the sound generation assembly 12 is arranged opposite to the third flexible member 113, this manner makes full use of the internal cavity space. The radius of the sound generation assembly 12 mentioned refers to a radius formed based on a radial direction of the diaphragm in the loudspeaker.

In some embodiments, referring to FIG. 3, the sound generation assembly 12 includes the mounting bracket 123. A protruding structure (i.e., the structure indicated by 125) is disposed on one side of the mounting bracket 123. The protruding structure has a sound transmission channel communicating with the loudspeaker in the sound generation assembly 12. Typically, the sound transmission channel needs to be at least partially aligned with the sound outlet hole 114. Therefore, in this embodiment, the protruding structure is located at the portion with the widest radius 125 of the sound generation assembly 12. Placing the protruding structure inside the third rigid housing 111 makes full use of the space inside the third rigid housing 111, allowing the use of the sound generation assembly 12 with the larger oscillator.

In some embodiments, referring to FIG. 3, in a radial direction of the sound generation assembly 12, the third flexible member 113 is not disposed in a region facing the portion with the widest radius 125 of the sound generation assembly 12. That is, it avoids compressing the internal space of the third rigid housing 111 due to coverage by the third flexible member 113, ensuring that the third rigid housing 111 has a larger internal space available for use.

In some embodiments, referring to FIG. 3, the third rigid housing 111 includes a groove, and the portion with the widest radius 125 of the sound generation assembly 12 is accommodated in the groove. By providing the groove on an inner wall of the third rigid housing 111, the internal space of the third rigid housing 111 can be expanded, thereby accommodating a larger sound generation assembly 12.

In some embodiments, the groove may be used to accommodate the positioning boss on the mounting bracket. The positioning boss may also serve as a sound outlet channel on the mounting bracket for guiding sound toward the sound outlet hole 114.

Further, the sound generation assembly 12 may include one or more loudspeakers. Based on reasonable utilization of the internal space of the third rigid housing 111, the arrangement of the sound generation assembly 12 may have various forms.

In some embodiments, referring to FIG. 3, a magnetic shield 122 of at least one loudspeaker is located within the fourth rigid housing 112 and faces the fourth rigid housing 112. The magnetic shield 122 has an end surface 1221 facing the fourth rigid housing 112. The end surface 1221 is a plane.

Further, in some embodiments, referring to FIG. 3, a plane where the outermost annular line of the end surface 113a of the third flexible member 113 is located is the first reference plane A1. On a section perpendicular to the first reference plane A1 and passing through a center of the end surface 112a of the fourth rigid housing 112 facing the magnetic shield 122, a curvature radius of a region on the fourth rigid housing 112 (here referring to the outer contour line of the fourth rigid housing 112) opposite to the end surface 1221 of the magnetic shield 122 is greater than a curvature radius of at least part of other regions located on two sides thereof. This allows a curvature of the fourth rigid housing 112 at this location to be set smaller, thereby leaving more space for a corresponding location of the third flexible member 113 on the outer side. This increases a thickness of the third flexible member 113 at this location without increasing an overall thickness of the second housing 11. This region is close to a contact center (i.e., a center position where the third flexible member 113 contacts the wearer). Setting a larger thickness can improve wearing comfort.

In some embodiments, referring to FIG. 3, on a second predetermined section, the curvature radius of the region on the fourth rigid housing 112 (here referring to the outer contour line of the fourth rigid housing 112) opposite to the end surface 1221 of the magnetic shield 122 is greater than the curvature radius of at least part of other regions located on two sides thereof. In the description of the present disclosure, unless otherwise specified, the “second predetermined section” refers to a section perpendicular to the first reference plane A1 and passing through the center of the end surface 112a of the fourth rigid housing 112 facing the magnetic shield 122 or refers to the ear hook symmetry plane A2. In this way, the curvature of the fourth rigid housing 112 at this location can be set smaller, thereby leaving more space for the third flexible member 113 on the outer side. This increases the thickness of the third flexible member 113 at this location without increasing the overall thickness of the second housing 11.

In some embodiments, referring to FIG. 3, a plane where the outermost annular line of the end surface 113a of the third flexible member 113 is located is the first reference plane A1. On a section perpendicular to the first reference plane A1 and passing through the center of an end surface 112a of the fourth rigid housing 112 facing the magnetic shield 122, a curvature radius R2 of the region on the third flexible member 113 (here referring to the outer contour line of the third flexible member 113) opposite to the magnetic shield 122 is in a range of 6 mm-18 mm. For example, R2 may be 6 mm, 8 mm, 10 mm, 12 mm, 14 mm, 16 mm, or 18 mm. This region is close to the contact center (i.e., the center position where the third flexible member 113 contacts the wearer). Setting a larger curvature radius can increase a contact area and improve comfort.

In some embodiments, referring to FIG. 3, on the second predetermined section, the curvature radius R2 of the region on the third flexible member 113 (here referring to the outer contour line of the third flexible member 113) opposite to the magnetic shield 122 is in a range of 6 mm-18 mm. For example, R2 may be 6 mm, 8 mm, 10 mm, 12 mm, 14 mm, 16 mm, or 18 mm. This region is close to the contact center. Setting a larger curvature radius can increase the contact area and improve comfort.

In some embodiments, referring to FIG. 3, the plane where the outermost annular line of the end surface 113a of the third flexible member 113 is located is the first reference plane A1. On the section perpendicular to the first reference plane A1 and passing through the center of the end surface 112a of the fourth rigid housing 112 facing the magnetic shield 122, a thickness of a region on the third flexible member 113 opposite to the end surface of the magnetic shield 122 is in a range of 0.8 mm-2 mm (e.g., 0.8 mm, 1.0 mm, 1.5 mm, or 2.0 mm). This region is close to the contact center. Setting a thicker silicone can improve comfort.

In some embodiments, referring to FIG. 3, on the second predetermined section, the thickness of the region on the third flexible member 113 opposite to the end surface of the magnetic shield 122 is in a range of 0.8 mm-2 mm (e.g., 0.8 mm, 1.0 mm, 1.5 mm, or 2.0 mm). This region is close to the contact center. Setting the thicker silicone can improve comfort.

In some embodiments, referring to FIG. 19, on the first predetermined section, a curvature radius of a predetermined region C1 on the outer contour line of the third flexible member 113 is greater than a curvature radius of at least part of other regions located on two sides thereof. The predetermined region C1 is close to a contact center C2 of the third flexible member 113 and the concha cavity (i.e., a center position where the third flexible member 113 contacts the wearer; as shown in FIG. 19, in some embodiments, a distance between the contact center C2 and an end of the third flexible member 113 close to the ear hook 3 is approximately one-third of a length of the outer contour line of the third flexible member 113). Since the predetermined region C1 is close to the contact center C2, by setting the predetermined region C1 to have a larger curvature radius, a contact area with the concha cavity can be increased, thereby improving wearing comfort.

The curvature radius of the predetermined region C1 may be in a range of 6 mm -18 mm (e.g., 6 mm, 8 mm, 10 mm, 12 mm, 14 mm, 16 mm, or 18 mm). This region is close to the contact center C2 (i.e., the center position where the third flexible member 113 contacts the wearer). Setting a larger curvature radius can increase the contact area and improve comfort.

A thickness of the third flexible member 113 within the predetermined region C1 may be in a range of 0.2 mm-1 mm (e.g., 0.2 mm, 0.5 mm, 0.8 mm, or 1.0 mm). Setting the thickness of the third flexible member 113 within the predetermined region C1 in this way can ensure wearing comfort while avoiding an increase in an overall size of the second housing.

In some embodiments, referring to FIG. 3, the sound generation assembly 12 includes an intermediate mounting bracket 123 (i.e., a specific form of the mounting bracket 123 for dual loudspeakers) and two loudspeakers. The two loudspeakers are jointly mounted on the intermediate mounting bracket 123. A sound transmission channel 1231 is formed between diaphragms 124 of the two loudspeakers. The central axis A3 of the sound outlet hole 114 passes through the sound transmission channel 1231. The dual loudspeaker design increases an area of the diaphragm 124 while occupying the same radial area, thereby improving a BL value of the loudspeaker under the same volume, which results in higher acoustic efficiency. Furthermore, the central axis A3 of the sound outlet hole 114 passes through the sound transmission channel 1231, making a path for sound to exit the second accommodating cavity 110 more open and direct.

In some embodiments, referring to FIG. 3, the sound transmission channel 1231 is a shared front cavity for the two loudspeakers. In this embodiment, the structure of the shared front cavity can further reduce a volume occupied by the dual loudspeakers.

In some embodiments, the sound transmission channel 1231 is a shared back cavity for the two loudspeakers. A waterproof and breathable membrane is provided on the sound outlet hole 114 and/or the sound transmission channel 1231. The structure of the shared back cavity can further reduce the volume occupied by the dual loudspeakers. Providing the waterproof and breathable membrane on the sound outlet hole 114 and/or the sound transmission channel 1231 can provide waterproof and dustproof capabilities with minimal impact on sound quality, thereby increasing reliability of the earphone.

In some embodiments, referring to FIG. 3, a plane where the outermost annular line of the end surface 113a of the third flexible member 113 is located is the first reference plane A1. On a section perpendicular to the first reference plane A1 and passing through a center of the mounting bracket 123 (i.e., a geometric center of the mounting bracket 123), lines connecting the center of the mounting bracket 123 and two endpoints of the third flexible member 113 form an included angle α2 of 130° to 160°. For example, the included angle α2 may be 130°, 140°, 150°, or 160°. Setting the coverage range of the third flexible member 113 in this way allows a contact point between the concha cavity and the silicone segment to be located closer to the center, thereby reducing a probability of the human ear contacting the rigid shell segment.

In some embodiments, referring to FIG. 3, on the section perpendicular to the first reference plane A1 and passing through the center of the mounting bracket 123 (i.e., the geometric center of the mounting bracket 123), lines connecting the center of the mounting bracket 123 and the two endpoints of the third flexible member 113 form the included angle α2 of 130° to 160°, or form the included angle α2 greater than 160° and less than or equal to 170°. For example, the included angle α2 may be 130°, 140°, 150°, 160°, or 170°. Setting the coverage range of the third flexible member 113 in this way allows the contact point between the concha cavity and the silicone segment to be located closer to the center, further reducing the probability of the human ear contacting the rigid shell segment.

In some embodiments, referring to FIG. 10, the sound generation assembly 12 includes the intermediate mounting bracket 123 (i.e., a specific structure of the mounting bracket applied to dual loudspeakers) and two loudspeakers. The two loudspeakers are jointly mounted on the intermediate mounting bracket 123. A connecting line A4 connecting centers of the magnetic shields 122 of the two loudspeakers passes through the third rigid housing 111, or the connecting line A4 connecting the centers of the magnetic shields 122 of the two loudspeakers does not pass through the fourth rigid housing 112 and the third flexible member 113. In this embodiment, a center of the entire sound generation assembly 12 can be made closer to the third rigid housing 111, thereby more fully utilizing the internal space of the third rigid housing 111.

In some embodiments, referring to FIG. 8, a side of the sound generation assembly 12 with the widest width along a radial direction and a side of the sound generation assembly 12 with the widest width along an axial direction are both arranged opposite to the third rigid housing 111.

In some embodiments, referring to FIG. 3, both sides of the sound generation assembly 12 with the widest width along the axial direction are arranged opposite to the third rigid housing 111. Since a space of the third rigid housing 111 is larger than a space of the fourth rigid housing 112, arranging both sides of the sound generation assembly 12 with the widest width along the axial direction opposite to the third rigid housing 111 allows selection of a sound generation assembly 12 with a larger oscillator to obtain better sound quality.

In some embodiments, referring to FIG. 8, the sound generation assembly 12 includes the mounting bracket 123 and at least one loudspeaker. The loudspeaker is mounted on the mounting bracket 123. A distance from a center 1232 of a side surface of the mounting bracket 123 opposite to the magnetic shield 122 to the first reference plane A1 is in a range of 0.4 mm-2 mm. For example, the distance may be 0.4 mm, 0.8 mm, 1.2 mm, 1.5 mm, or 2 mm. The first reference plane A1 is the plane where the outermost annular line of the end surface 113a of the third flexible member 113 is located. Alternatively, the ear hook symmetry plane A2 of the ear hook 3 intersects the outermost annular line of the end surface 113a of the third flexible member 113 to form two intersection points. The first reference plane A1 is a plane perpendicular to the ear hook symmetry plane A2 and passing through the two intersection points.

In some embodiments, the sound generation assembly 12 includes the mounting bracket 123 and at least one loudspeaker. The loudspeaker is mounted on the mounting bracket 123. The distance from the center 1232 of the side surface of the mounting bracket 123 opposite to the magnetic shield 122 to the first reference plane A1 is in a range of 0.4 mm-2 mm, or greater than 2 mm and less than or equal to 3 mm. For example, the distance may be 0.4 mm, 0.8 mm, 1.2 mm, 1.5 mm, 2 mm, 2.5 mm, or 3 mm.

Setting the position of the sound generation assembly within the second housing 11 in this way allows more volume of the sound generation assembly to be distributed towards the third rigid housing 111, thereby fully utilizing the relatively abundant internal space of the third rigid housing 111, which enables the second housing 11 to accommodate a sound generation unit with a larger volume.

In some embodiments, as shown in FIG. 19, the ear hook 3 has the ear hook symmetry plane A2 arranged along its length direction. The ear hook symmetry plane A2 intersects the outermost annular line of the end surface of the third flexible member 113 to form two intersection points. On the ear hook symmetry plane A2, the ear hook 3 has an inner contour line. The inner contour line has a first reference point O1 in a region close to the auricle of the wearer. The inner contour line has a local maximum curvature at the first reference point O1. An included angle α12 formed by lines connecting the first reference point O1 and the two intersection points is less than or equal to 15°. For example, α12 may be 3°, 5°, 8°, 11°, or 15°.

In some embodiments, as shown in FIG. 19, the ear hook 3 has the ear hook symmetry plane A2 arranged along its length direction. The ear hook symmetry plane A2 intersects the outermost annular line of the end surface of the third flexible member 113 to form two intersection points. On the ear hook symmetry plane A2, an outer wall of the sound generation portion 1 has a second reference point O2. A distance between the second reference point O2 and an outer wall of the abutting portion 2 is the shortest. An included angle α13 formed by lines connecting the second reference point O2 and the two intersection points is between 85° and 115°. For example, α13 may be 85°, 90°, 100°, 105°, or 115°.

In some embodiments, when the earphone is in a natural state (i.e., without external force intervention), on the ear hook symmetry plane A2, the sound generation portion 1 and the abutting portion 2 are arranged spaced apart. In this case, the second reference point O2 refers to an endpoint of a shortest connecting line between the sound generation portion 1 and the abutting portion 2 on the sound generation portion 1. In some embodiments, when the earphone is in a natural state (i.e., without external force intervention), on the ear hook symmetry plane A2, the sound generation portion 1 and the abutting portion 2 abut against each other. In this case, the second reference point O2 refers to a midpoint of an arc segment formed by an abutting area between the sound generation portion 1 and the abutting portion 2 on the ear hook symmetry plane A2. Setting the wrap angle of the third flexible member 113 in this way can satisfy that a contact area between a human ear and the second housing for most people or standard head models is covered by the third flexible member 113, thereby ensuring comfort, also leaving more space for the third rigid housing 111, which ensures that an internal cavity volume is not excessively occupied by the silicone region.

In some embodiments, referring to FIG. 10, a tangent line of the ear hook 3 and the first reference plane A1 form an included angle θ2 of 18° to 35°. The first reference plane A1 is the plane where the outermost annular line of the end surface 113a of the third flexible member 113 is located. Alternatively, the ear hook symmetry plane A2 of the ear hook 3 intersects the outermost annular line of the end surface 113a of the third flexible member 113 to form two intersection points. The first reference plane A1 is a plane perpendicular to the ear hook symmetry plane A2 and passing through the two intersection points.

Setting the positional relationship between the ear hook 3 and the second housing 11 in this way allows an extension direction of the ear hook 3 after the earphone is worn to be nearly parallel to an extension direction of the auricle, reducing a degree of squeezing between the ear hook 3 and the auricle or avoiding squeezing the auricle, thereby improving wearing comfort of the clip-on earphone.

In some embodiments, referring to FIG. 10, a distance D10 between a tangent line of the ear hook 3 and the first reference plane A1 is in a range of 6 mm-8 mm. The first reference plane A1 is the plane where the outermost annular line of the end surface 113a of the third flexible member 113 is located. Alternatively, the ear hook symmetry plane A2 of the ear hook 3 intersects the outermost annular line of the end surface 113a of the third flexible member 113 to form two intersection points. The first reference plane A1 is a plane perpendicular to the ear hook symmetry plane A2 and passing through the two intersection points.

In some embodiments, referring to FIG. 3, the plane where the outermost annular line of the end surface 113a of the third flexible member 113 is located is the first reference plane A1. On a section perpendicular to the first reference plane A1 and passing through a center of the first reference plane A1, a length of the third flexible member 113 (specifically referring to a length of the outer contour line of the third flexible member 113) is in a range of 16 mm-25 mm (e.g., 16 mm, 19 mm, 21 mm, 23 mm, or 25 mm).

In some embodiments, referring to FIG. 3, on the first predetermined section, the length of the outer contour line of the third flexible member is in a range of 16 mm-25 mm (e.g., 16 mm, 19 mm, 21 mm, 23 mm, or 25 mm).

Setting the length of the outer contour line of the third flexible member 113 in this way is conducive to avoiding direct contact between the rigid housing and the skin in a wearing state, thereby ensuring wearing comfort. It also leaves more space for the third rigid housing 111, ensuring that the internal cavity volume is not excessively occupied by the silicone region.

In some embodiments, referring to FIG. 11, the plane where the outermost annular line of the end surface 113a of the third flexible member 113 is located is the first reference plane A1. On the section perpendicular to the first reference plane A1 and passing through the center of the first reference plane A1, an end of the third flexible member 113 closer to the ear hook 3 is a first end 113a, and an end of the third flexible member 113 farther from the ear hook 3 is a second end 113b. In a region of the third flexible member 113 at one-third of a distance D8 from the end surface of the second end 113b, a thickness of the third flexible member 113 along a normal direction of the outer wall is in a range of 0.8 mm-2.0 mm (e.g., 0.8 mm, 1.2 mm, 1.5 mm, 1.8 mm, or 2.0 mm).

In some embodiments, referring to FIG. 11, on the first predetermined section, the end of the third flexible member 113 closer to the ear hook 3 is the first end 113a, and the end of the third flexible member 113 farther from the ear hook 3 is the second end 113b. In the region of the third flexible member 113 at one-third of the distance D8 from the end surface of the second end 113b, the thickness of the third flexible member 113 along the normal direction of the outer wall is in a range of 0.8 mm-2.0 mm (e.g., 0.8 mm, 1.2 mm, 1.5 mm, 1.8 mm, or 2.0 mm).

According to the standard head model, under a condition where the second housing 11 is approximately spherical, a connection tangent between the ear hook and the second housing 11 and the first reference plane form an angle of 18°-35°, a distance between the tangent line of the ear hook and the first reference plane is in a range of 6 mm-8 mm, and a length of the third flexible member is in a range of 16 mm-25 mm, a contact center region of the second housing 11 and the standard head model is located in a region of the third flexible member at one-third of a distance from the end surface of the second end. Setting the thickness of the third flexible member at this location in this way allows the contact center region to be close to a midpoint of the length of the third flexible member, reduces a probability of a human ear contacting a rigid housing, and also takes into account reducing a volume of the second housing 11 to ensure an open listening effect.

In some embodiments, referring to FIG. 19, a contact center region C2 between the second housing 11 and the standard human head model is located at a region of the third flexible member 113 at one-third of the distance from the end surface of the first end 113a. In this situation, in the first predetermined section, in the region of the third flexible member 113 at one-third of the distance from the end surface of the first end 113a, the thickness of the third flexible member 113 along the normal direction of the outer wall is in a range of 0.8 mm-2.0 mm (e.g., 0.8 mm, 1.2 mm, 1.5 mm, 1.8 mm, or 2.0 mm). Setting the thickness of the third flexible member at this location in this way allows the contact center region to be close to the midpoint of the length of the third flexible member, reduces a probability of a human ear contacting the rigid housing, and also takes into account reducing the volume of the second housing 11 to ensure the open listening effect.

In some embodiments, referring to FIG. 12, the plane where the outermost annular line of the end surface 113a of the third flexible member 113 is located is the first reference plane A1. On the section perpendicular to the first reference plane A1 and passing through the center of the first reference plane A1, a three-point arc is fitted according to two endpoints of the outer wall of the third flexible member 113 and a midpoint of the third flexible member 113. A circle center of the three-point arc is taken as an acoustic cavity center, and an included angle γ1 formed by connecting lines between the acoustic cavity center and the two endpoints is in a range of 145°-170°. For example, the included angle may be 145°, 150°, 155°, 160°, 165°, or 170°.

In some embodiments, on the first predetermined section, the three-point arc is fitted according to the two endpoints of the outer wall of the third flexible member 113 and the midpoint of the third flexible member 113. The circle center of the three-point arc is taken as the acoustic cavity center. The included angle γ1 formed by connecting the lines between the acoustic cavity center and the two endpoints of the third flexible member 113 is in a range of 145°-170° (including endpoint values), or is greater than 170° and less than or equal to 178°. For example, the included angle γ1 may be 145°, 150°, 155°, 160°, 165°, 170°, 172°, 175°, or 178°.

In some embodiments, referring to FIG. 11, the plane where the outermost annular line of the end surface 113a of the third flexible member 113 is located is the first reference plane A1. On the section perpendicular to the first reference plane A1 and passing through the center of the first reference plane A1, lines connecting the two endpoints of the outer wall of the third flexible member 113 and the midpoint 113c of the outer wall of the third flexible member 113 form an included angle β1 of 90°-100°. For example, the included angle β1 may be 90°, 92°, 94°, 96°, 98°, or 100°.

In some embodiments, on the first predetermined section, the lines connecting the two endpoints of the outer wall of the third flexible member 113 and the midpoint 113c of the outer wall of the third flexible member 113 form the included angle β1 of 90°-100°. For example, the included angle β1 may be 90°, 92°, 94°, 96°, 98°, or 100°.

Setting the included angle of the third flexible member 113 in this way can ensure that a contact area between the human ear and the second housing covers the third flexible member 113 for most people or under the standard head model, thereby ensuring comfort, and also takes into account leaving more space for the third rigid housing 111, thereby ensuring that an internal cavity volume is not excessively occupied by the silicone region.

In some embodiments, referring to FIG. 10 (FIG. 10 shows positions of two sound outlet holes, one of which is indicated by a reference numeral 114, and the other optional position is indicated by a reference numeral 114a in the figure), the plane where the outermost annular line of the end surface 113a of the third flexible member 113 is located is the first reference plane A1. On the section perpendicular to the first reference plane A1 and passing through the center of the first reference plane A1, the end of the third flexible member 113 closer to the ear hook 3 is the first end 113a, and the end of the third flexible member 113 farther from the ear hook 3 is the second end 113b. A connecting line from the first end 113a to a contact center of the outer wall of the third flexible member 113 and a connecting line from the first end 113a to a center of upper and lower positions of the sound outlet hole 114 form an included angle θ1 of 10°-85°. For example, the included angle θ1 may be 10°, 20°, 30°, 50°, 70°, 80°, or 85°.

In some embodiments, on the first predetermined section, the end of the third flexible member 113 closer to the ear hook 3 is the first end 113a, and the end of the third flexible member 113 farther from the ear hook 3 is the second end 113b. The connecting line from the first end 113a to the contact center of the outer wall of the third flexible member 113 and the connecting line from the first end 113a to the center of the upper and lower positions of the sound outlet hole 114 form the included angle θ1 of 10°-85°. For example, the included angle θ1 may be 10°, 20°, 30°, 50°, 70°, 80°, or 85°. Setting the position of the sound outlet hole 114 in this way can provide better directivity of the sound outlet hole 114 towards the ear canal, thereby obtaining a greater listening volume.

In some embodiments, the contact center region of the second housing 11 and the standard head model is located in the region of the third flexible member 113 at one-third of the distance from the end surface of the second end. An included angle between a connecting line from an endpoint of the first reference plane closer to the ear hook to a center of the sound outlet hole 114 and a connecting line from the endpoint of the first reference plane closer to the ear hook to the contact center is between 10° and 85°.

Under a condition where the second housing is approximately spherical, a connection tangent line between the ear hook and the second housing and the first reference plane form an angle of 18°-35°, and a distance between the tangent line of the ear hook and the first reference plane is in a range of 6 mm-8 mm. Setting the position of the sound outlet hole 114 in this way allows a normal direction of the sound outlet hole 114 to point towards the ear canal, thereby obtaining the greater listening volume.

In some embodiments, an included angle between an installation plane where the diaphragm of the loudspeaker is located and an ear hook symmetry plane arranged along a length direction thereof is less than 10°. Setting the included angle in this way allows a curve formed by an outer ring of the loudspeaker cutting the second housing 11 and the concha cavity to form a wedge-shaped space. When the sound outlet hole 114 is arranged along the curve, the sound outlet hole 114 and the concha cavity may form a horn structure, and using the concha cavity as a reflective wall surface can form a horn effect, thereby increasing the listening volume.

In some embodiments, the third flexible member 113 and the fourth rigid housing 112 are an integrally processed structure or a fixedly connected integrated structure. Therefore, the third flexible member 113 and the fourth rigid housing 112 may be pre-processed into one component and then installed together onto the third rigid housing 111.

In some embodiments, referring to FIG. 14, on a section passing through the plane where the outermost annular line of the end surface 113a of the third flexible member 113 is located, a ratio of two widths (D11 and D12) of the second housing 11 in orthogonal directions is between 0.8 and 1.2. In this embodiment, the ratio of the two widths being 0.8-1.2 makes the entire second accommodating cavity 110 approximately spherical, so as to obtain a transducer cavity that is more suitable for wearing, has a larger volume, and is easy to assemble.

In some embodiments, on the first predetermined section, the ratio of the two widths (D11 and D12) of the second housing 11 in the orthogonal directions is between 0.8 and 1.2. In this embodiment, the ratio of the two widths being 0.8-1.2 makes the entire second accommodating cavity 110 approximately spherical, so as to obtain the transducer cavity that is more suitable for wearing, has the larger volume, and is easy to assemble.

In some embodiments, a thickness of a contact area on the third flexible member 113 that contacts the concha cavity in a wearing state is greater than thicknesses of other regions. On one hand, setting a larger thickness in the contact area can improve wearing comfort. On the other hand, setting smaller thicknesses in other regions is beneficial for controlling an overall size of the sound generation portion 1.

In some embodiments, based on the standard head model, the second housing 11 has a size and a shape that are capable of not blocking the ear canal of the wearer when worn.

In some embodiments, the abutting portion 2 includes a first housing 21. The first housing 21 includes a first rigid housing 211, a second rigid housing 212 for facing the back of the wearer's ear when worn, and a first flexible member 213 for contacting the back of the wearer's ear. The first rigid housing 211 and the second rigid housing 212 enclose to form a first accommodating cavity 210. The first flexible member 213 covers an outer wall of the second rigid housing 212. An outer wall of the first rigid housing 211 is not covered by the first flexible member 213 and is in an exposed state, or the first flexible member 213 extends from the outer side of the second rigid housing 212 to an outer side of the first rigid housing 211 and covers a part of the outer wall of the first rigid housing 211, so that the remaining outer wall of the first rigid housing 211 is in the exposed state.

According to the clip-on earphone 100 of the above embodiment, the clip-on earphone 100 includes the sound generation portion 1, the abutting portion 2, and the ear hook connecting the sound generation portion 1 and the abutting portion 2. The abutting portion 2 includes the first rigid housing 211, the second rigid housing 212, and the first flexible member 213. The first rigid housing 211 and the second rigid housing 212 enclose to form the first accommodating cavity 210. The first rigid housing 211 and the second rigid housing 212 can provide better support for the internal structures. Usually, the second rigid housing 212 faces the back of the wearer's ear when worn. In this embodiment, the first flexible member 213 covers the outer wall of the second rigid housing 212 to reduce a possibility of the second rigid housing 212 directly contacting the wearer's skin, thereby improving comfort of the earphone when worn. In this situation, in the abutting portion 2, the first flexible member 213 mainly covers the second rigid housing 212, basically not affecting an external structure and an internal space of the first rigid housing 211, thereby ensuring utilization of the internal space of the first rigid housing 211.

Further, in some embodiments, referring to FIG. 2 and FIG. 14, the abutting portion 2 includes the first housing 21. The first housing 21 includes the first rigid housing 211, the second rigid housing 212 for facing the back of the wearer's ear when worn, and the first flexible member 213 for contacting the back of the wearer's ear. The first rigid housing 211 and the second rigid housing 212 enclose to form the first accommodating cavity 210. The first flexible member 213 covers the outer wall of the second rigid housing 212. A thickness of a region of the second rigid housing 212 covered by the first flexible member 213 is less than a thickness of the first rigid housing 211. The outer wall of the second rigid housing 212 is covered by the first flexible member 213, so that a portion of the second rigid housing 212 has a double-layer wall thickness. The outer wall of the first rigid housing 211 is not covered by the first flexible member 213, so a portion of the first rigid housing 211 only requires a single-layer wall thickness, which makes the portion of the first rigid housing 211 occupy a smaller volume of the first accommodating cavity 210, leaves more space for a battery, allows placement of a larger battery, and increases battery life of the earphone.

Similar to structures of the third rigid housing 111 and the fourth rigid housing 112, in some embodiments, an end portion of the first rigid housing 211 and an end portion of the second rigid housing 212 are spliced and fixed. A portion of the outer wall of the second rigid housing 212 not covered by the first rigid housing 211 is entirely covered by the first flexible member 213.

Similar to the structures of the third rigid housing 111 and the fourth rigid housing 112, the first flexible member 213 extends from an outer side of the second rigid housing 212 to an outer side of the first rigid housing 211 and covers a portion of an outer wall of the first rigid housing 211.

Similar to the structures of the third rigid housing 111 and the fourth rigid housing 112, an end surface of the first flexible member 213 extends to an end surface of the first rigid housing 211. Benefiting from a flexible deformation characteristic of the first flexible member 213, cooperation between the end surface of the first flexible member 213 and the end surface of the first rigid housing 211 can form a good sealing and waterproof effect.

Similar to the structures of the third rigid housing 111 and the fourth rigid housing 112, the end surface of the first flexible member 213 and the end surface of the first rigid housing 211 may also have a gap, so that the first flexible member 213 has sufficient deformation space when being squeezed and deformed.

Similar to the structures of the third rigid housing 111 and the fourth rigid housing 112, the end surface of the first flexible member 213 and an outermost annular line of an end surface of the second rigid housing 212 are flush in an inner-outer direction, or the first flexible member 213 does not cover the outer wall of the first rigid housing 211.

Similar to the structures of the third rigid housing 111 and the fourth rigid housing 112, the end surface of the first rigid housing 211 and the end surface of the second rigid housing 212 have a gap. The first flexible member 213 extends into the gap and is clamped and fixed by the end surface of the first rigid housing 211 and the end surface of the second rigid housing 212. Such a cooperation manner can make the first flexible member 213 and the second rigid housing 212 cooperate more closely. In this situation, through a clamping effect between the first rigid housing 211 and the second rigid housing 212, a better sealing and waterproof effect can also be formed.

Similar to the structures of the third rigid housing 111 and the fourth rigid housing 112, the end surface of the first rigid housing 211 and the end surface of the second rigid housing 212 are a pair of mutually adapted planes which may be inclined surfaces, stepped surfaces, folded surfaces, wavy surfaces, or a combination of at least two thereof.

In some embodiments, the first housing 21 has a strip shape structure. In a section perpendicular to a length direction of the first housing 21, a ratio of a line connecting two ends of the first flexible member 213 to a radial dimension of the housing is greater than or equal to 0.9 and less than or equal to 1, that is, a ratio of the line connecting the two ends of the first flexible member 213 to a maximum radial dimension of the housing is between 0.9 and 1. For example, the ratio may be 0.9, 0.92, 0.94, 0.96, 0.98, or 1. This setting manner limits a coverage region where the first flexible member 213 covers the first housing 21 to a certain range. If the range is too small, the covered area is too small, causing an ear to contact the housing during use of the earphone. If the range where the first flexible member covers the first housing is too large, it causes “over-coverage” resulting in that a coverage is also performed on the housing that will not contact the ear, which compresses a space of the first accommodating cavity 210 and reduces space utilization. In the solution of the present disclosure, the described “between A and B” or “located between A and B” includes the endpoint value A and the endpoint value B.

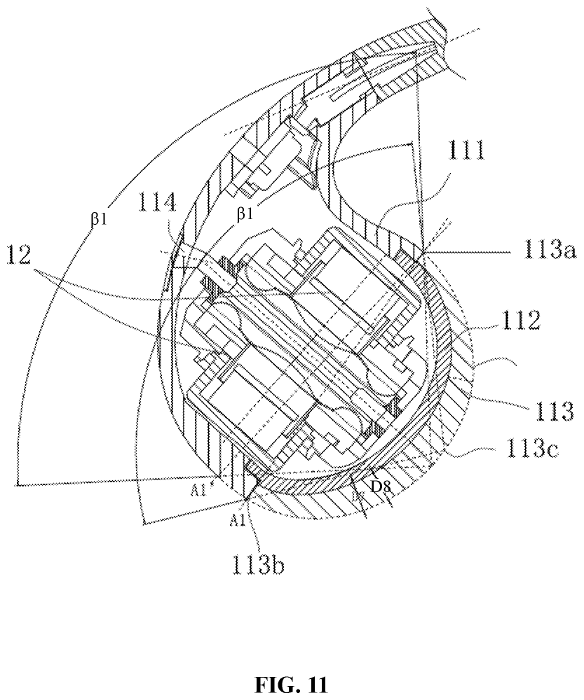

In some embodiments, referring to FIG. 15, the first housing 21 has the strip shape structure. In the section perpendicular to the length direction of the first housing 21, a distance D13 from a midpoint of an outer wall of the first flexible member 213 to the tangent line of the ear hook 3 is in a range of 9 mm-13 mm. This distance value being greater than 9 mm ensures that after the first housing 21 extends into a wearing position of the ear, the ear hook 3 does not squeeze the auricle. And this distance not exceeding 13 mm limits a volume of the earphone, preventing an earphone form from being too large, so that a center of gravity does not deviate too much from an outer side of the human body, which would cause the earphone to easily fall off.

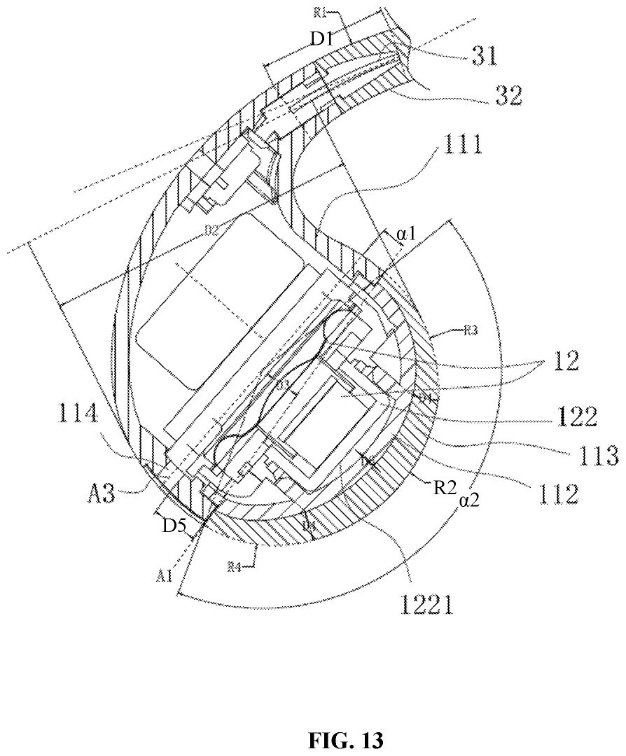

In some embodiments, referring to FIG. 17, the first rigid housing 211 is a U-shaped structure, that is, the first rigid housing 211 includes a connection wall 2111 and two side walls 2112. The two side walls 2112 are disposed at two opposite ends of the connection wall 2111. The second rigid housing 212 is located between the two side walls 2112 of the U-shaped structure. The first rigid housing 211 includes the connection wall 2111. The connection wall 2111 and the second rigid housing 212 are spliced to form an annular peripheral wall of the abutting portion 2. A direction of a line connecting two side walls is defined as a horizontal direction. A direction perpendicular to the horizontal direction and away from the second rigid housing 212 is defined as a vertical direction. This arrangement causes the first rigid housing 211 to generate an abutting force on the side walls when shaking in the horizontal direction. In the vertical direction, there is a seam between the first rigid housing 211 and the second rigid housing 212. A longer seam in this direction makes it more difficult to separate the first rigid housing 211 and the second rigid housing 212 after bonding, making the bonding of the two housings more firm and more reliable. Moreover, two side surfaces of the first rigid housing 211 are complete planes. Accordingly, when arranging an antenna or a touch circuit, it is not necessary to arrange them across housings, leaving a large space for the arrangement of the antenna and the touch circuit and facilitating assembly. Since the first flexible member 213 only covers the second rigid housing 212, the U-shaped structure arrangement prevents the first flexible member 213 from extending to a side surface of the first rigid housing 211 that is touched. It is not necessary to cause more severe wear to a rubber layer due to touch or other reasons, and it is not easy to debond.

In some embodiments, referring to FIG. 17, at least one side wall of the U-shaped structure is a mounting base. An antenna and/or a touch circuit board are installed on the mounting base. Setting at least one side wall as the mounting base ensures that when arranging the antenna or the touch circuit, it is not necessary to arrange them across housings, leaving a large space for the arrangement of the antenna and the touch circuit and facilitating assembly. Since the first flexible member 213 only covers the second rigid housing, the U-shaped structure arrangement prevents the first flexible member 213 from extending to a side surface of the first rigid housing 211 that is touched. It is not necessary to cause more severe wear to the first flexible member 213 due to touch or other reasons, and it is not easy to debond.

In some embodiments, both the first rigid housing 211 and the second rigid housing 212 are provided with a circular side wall and a semi-cylindrical side surface (which may also be referred to as a connection wall), similar to an L-shaped structure. Bottom surfaces of the two housings are opposite to each other. The semi-cylindrical side surfaces complement each other to form a complete cylindrical cavity. That is, the connection wall of the first rigid housing 211 and the connection wall of the second rigid housing 212 are spliced to form an annular peripheral wall of the abutting portion 2. This arrangement retains the complete side wall to provide a position for mounting the antenna and/or the touch circuit board, and also makes the assembly manner simpler and more direct, increasing assembly efficiency. The side wall of the first rigid housing 211 may serve as the mounting base for mounting the antenna and/or the touch circuit board. The side wall of the second rigid housing 212 may also serve as the mounting base for mounting the antenna and/or the touch circuit board. One of the side walls may serve as the mounting base, or both side walls may simultaneously serve as the mounting bases.

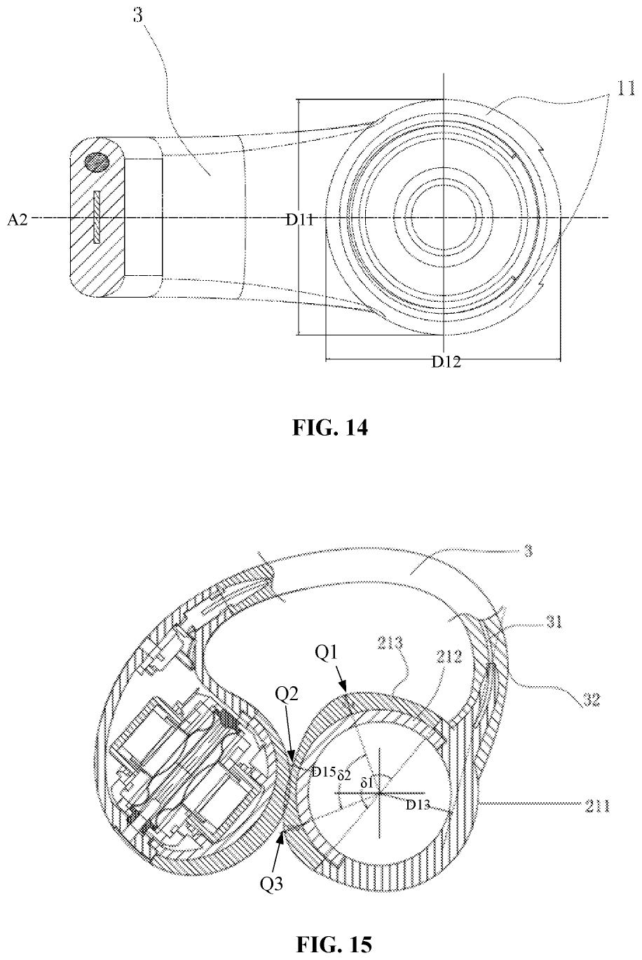

In some embodiments, referring to FIG. 18, both the first rigid housing 211 and the second rigid housing 212 have a cover-buckle-shaped structure. At least one side wall of the first rigid housing 211 and at least one side wall of the second rigid housing 212 are spliced to form the mounting base. The first flexible member 213 covers at least a portion of the mounting base.

In some embodiments, referring to FIG. 18, the first rigid housing 211 and the second rigid housing 212 may also form an integrated structure. The first flexible member 213 covers the second rigid housing 212, and the first flexible member 213 has a side wall 2131. The side wall 2131 may at least partially cover a side wall 2121 of the second rigid housing 212.

In some embodiments, the first flexible member 213 covers the second rigid housing 212 and the ear hook 3, and the first flexible member 213, the second rigid housing 212, and the ear hook 3 are integrally injection-molded. This production manner causes the first flexible member 213 to cover a joint surface between the second rigid housing 212 and the ear hook 3, which can prevent the joint surface between the second rigid housing 212 and the ear hook 3 from being exposed, increasing reliability and aesthetics of the earphone.

In some embodiments, referring to FIG. 1 and FIG. 15, in a natural state, the sound generation portion 1 and the abutting portion 2 abut against each other, and the third flexible member 113 and the first flexible member 213 remain in contact. The two contact each other to maintain a preload force, and when taken off from the wearing state, the contact between the two flexible members buffers an impact between the sound generation portion 1 and the abutting portion 2.

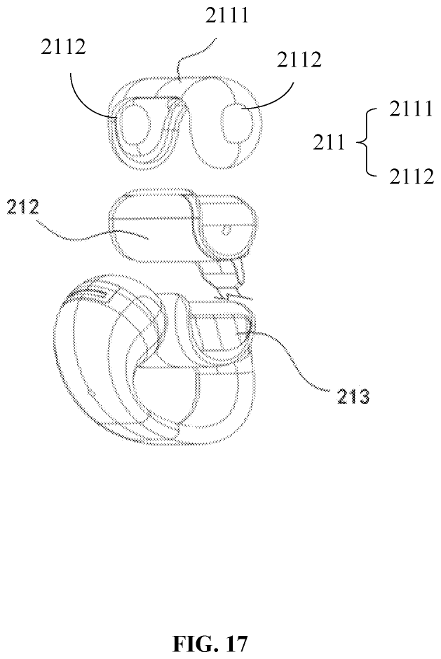

In some embodiments, referring to FIG. 1 and FIG. 20, in the natural state, an outer wall of the first flexible member 213 has a concave surface 2130 facing the third flexible member 113. When the earphone 100 is in the natural state, the third flexible member 113 contacts at least a portion of the concave surface 2130. The concave surface is designed to adapt to a shape of soft tissue at the back of the wearer's ear and a head portion opposite to the back of the wearer's ear, increasing a contact area, reducing pressure, and improving wearing comfort. In this situation, the contact between the sound generation portion 1 and the concave surface can also reduce an abrupt impact force from the wearing state to the natural state.

In some embodiments, in a section perpendicular to the length direction of the first housing 21, a depth L0 of the concave surface 2130 is between 0.07 and 0.25 (e.g., 0.07, 0.1, 0.15, 0.20, or 0.25). Setting the depth of the concave surface 2130 in this way can adapt to the shape of the soft tissue at the back of the wearer's ear and the head portion opposite to the back of the wearer's ear, increase the contact area, reduce the pressure, and improve the wearing comfort.

In some embodiments, the first housing 21 has the strip shape. In a section perpendicular to the length direction of the first housing 21 and passing through a midpoint of the length direction, an outer wall of the concave surface of the first flexible member 213 is recessed into an interior of the first housing 21.

In other embodiments, the first housing 21 has the strip shape. In the section perpendicular to the length direction of the first housing 21 and passing through the midpoint of the length direction, the first flexible member 213 has a shape that is thin in the middle and thick at both ends. This arrangement makes a curvature of the first flexible member 213 in a direction close to a human ear more ergonomically designed for the human ear, causing the first housing 21 to have a larger contact area with the ear and reducing pressure caused by the earphone on the ear.

In some embodiments, referring to FIG. 15, the first housing 21 has the strip shape. In the section perpendicular to the length direction of the first housing 21, lines connecting two ends of the first flexible member 213 (i.e., two endpoints of an outer contour line of the first flexible member 213) and a centroid of the first accommodating cavity 210 form an included angle δ1 greater than or equal to 160. For example, the included angle δ1 may be 160°, 165°, 170°, or 175°. If a coverage range (an angle) of the first flexible member is too small, in the wearing state, the rigid housing may contact skin of the wearer, resulting in insufficient comfort.

In some embodiments, the first housing 21 has the strip shape. In the section perpendicular to the length direction of the first housing 21, lines connecting the centroid of the first accommodating cavity 210 and the two endpoints of the outer contour line of the first flexible member 213 form the included angle δ1 greater than or equal to 160° or form the included angle δ1 greater than or equal to 145° and less than 160°. For example, the included angle δ1 may be 145°, 150°, 160°, 165°, 170°, or 175°. If the coverage range (the angle) of the first flexible member is too small, in the wearing state, the rigid housing may contact the skin of the wearer, resulting in insufficient comfort.

In some embodiments, the first housing 21 has the strip shape. In the section perpendicular to the length direction of the first housing 21, an arc length of the first flexible member 213 (here referring to an arc length of the outer contour line of the first flexible member 213) is greater than or equal to 18 mm. For example, the arc length may be 18 mm, 20 mm, 22 mm, 24 mm, or 25 mm. If the arc length of the outer contour line of the first flexible member 213 is too small, in the wearing state, the rigid housing may contact the skin of the wearer, resulting in insufficient comfort.

In some embodiments, the first housing 21 has the strip shape. In the section perpendicular to the length direction of the first housing 21, the arc length of the outer contour line of the first flexible member 213 is greater than or equal to 18 mm, or greater than or equal to 12 mm and less than 18 mm. For example, the arc length may be 12 mm, 14 mm, 16 mm, 18 mm, 20 mm, 22 mm, 24 mm, or 25 mm. If the arc length of the outer contour line of the first flexible member 213 is too small, in the wearing state, the rigid housing may contact the skin of the wearer, resulting in insufficient comfort.

In some embodiments, referring to FIG. 2, the ear hook 3 has a support rib 31 and a second flexible member 32. The second flexible member 32 wraps around the support rib 31. The first flexible member 213 and the second flexible member 32 are an integrally formed monolithic structure. This arrangement can eliminate a parting line between the ear hook 3 and the abutting portion 2, making a transition smoother and increasing stability at a connection of the product.

In some embodiments, the first flexible member 213 and the second flexible member 32 are separately arranged and do not contact each other, which allows the preparation of the second flexible member 32 and the first flexible member 213 to be separated, reducing process complexity. In other embodiments, the support rib 31 may be omitted from the ear hook 3.

In some embodiments, referring to FIG. 15, the first housing 21 has the strip shape. In the section perpendicular to the length direction of the first housing 21, the outer wall of the first flexible member 213 has a first point Q1, a second point Q2, and a third point Q3 distributed sequentially along its arc length. A distance from the first point to the centroid of the first accommodating cavity 210 and a distance from the third point to the centroid of the first accommodating cavity 210 are both greater than a distance from the second point to the centroid of the first accommodating cavity 210. This arrangement can adapt to the shape of the soft tissue at the back of the wearer's ear and the head portion opposite to the back of the wearer's ear, increase the contact area, reduce the pressure, and improve the wearing comfort.

In some embodiments, referring to FIG. 15, the first housing 21 has the strip shape. In the section perpendicular to the length direction of the first housing 21, the second point is located at a midpoint of the outer wall of the first flexible member 213. This arrangement can adapt to the shape of the soft tissue at the back of the wearer's ear and the head portion opposite to the back of the wearer's ear, increase the contact area, reduce the pressure, and improve the wearing comfort.

In some embodiments, referring to FIG. 15, the first housing 21 has the strip shape. In the section perpendicular to the length direction of the first housing 21, an included angle formed by a connecting line from the first point to the centroid of the first accommodating cavity 210 and a connecting line from the second point to the centroid of the first accommodating cavity 210 is equal to an included angle formed by the connecting line from the second point to the centroid of the first accommodating cavity 210 and a connecting line from the third point to the centroid of the first accommodating cavity 210. This arrangement can adapt to the shape of the soft tissue at the back of the wearer's ear and the head portion opposite to the back of the wearer's ear, increase the contact area, reduce the pressure, and improve the wearing comfort.

In some embodiments, referring to FIG. 15, the distance from the first point to the centroid of the first accommodating cavity 210 is equal to the distance from the third point to the centroid of the first accommodating cavity 210. This arrangement can adapt to the shape of the soft tissue at the back of the wearer's ear and the head portion opposite to the back of the wearer's ear, increase the contact area, reduce the pressure, and improve the wearing comfort.

In some embodiments, a difference between a thickness of the first flexible member 213 at the first point and a thickness of the first flexible member 213 at the second point is between 0.2 mm and 0.5 mm, and/or a difference between a thickness of the first flexible member 213 at the third point and the thickness of the first flexible member 213 at the second point is between 0.2 mm and 0.5 mm. This arrangement can adapt to the shape of the soft tissue at the back of the wearer's ear and the head portion opposite to the back of the wearer's ear, increase the contact area, reduce the pressure, and improve the wearing comfort.

In some embodiments, a difference between a thickness D14 of the first flexible member 213 at the first point Q1 and a thickness D15 of the first flexible member 213 at the second point Q2 is between 0.2 mm and 0.5 mm, or less than or equal to 0.2 mm. And/or, a difference between a thickness D16 of the first flexible member 213 at the third point Q3 and the thickness D15 of the first flexible member 213 at the second point Q2 is between 0.2 mm and 0.5 mm, or less than or equal to 0.2 mm. This arrangement can adapt to the shape of the soft tissue at the back of the wearer's ear and the head portion opposite to the back of the wearer's ear, increase the contact area, reduce the pressure, and improve the wearing comfort.

In some embodiments, referring to FIG. 15, the thickness D14 of the first flexible member 213 at the first point is between 1.4 mm and 1.7 mm, and/or the thickness D15 of the first flexible member 213 at the second point is between 1.0 mm and 1.3 mm, and/or the thickness D16 of the first flexible member 213 at the third point is between 1.4 mm and 1.7 mm. The thickness direction is a thickness perpendicular to a normal direction of the outer wall. The purpose of this arrangement is to adapt to the shape of the soft tissue at the back of the wearer's ear and the head portion opposite to the back of the wearer's ear, increase the contact area, reduce the pressure, and improve the wearing comfort.

In some embodiments, referring to FIG. 15, the thickness D14 of the first flexible member 213 at the first point is between 1.4 mm and 1.7 mm, or is greater than or equal to 0.3 mm and less than or equal to 1.4 mm; and/or the thickness D15 of the first flexible member 213 at the second point is between 1.0 mm and 1.3 mm, or is greater than or equal to 0.2 mm and less than or equal to 1.3 mm; and/or the thickness D16 of the first flexible member 213 at the third point is between 1.4 mm and 1.7 mm, or is greater than or equal to 0.3 mm and less than or equal to 1.4 mm. The thickness direction is the thickness perpendicular to the normal direction of the outer wall. This arrangement aims to adapt to the shape of the soft tissue at the back of the wearer's ear and the head portion opposite the back of the wearer's ear, increase the contact area, reduce the pressure, and improve the wearing comfort.

In some embodiments, referring to FIG. 15, the connecting line from the first point to the centroid of the first accommodating cavity 210 and the connecting line from the third point to the centroid of the first accommodating cavity 210 form an included angle δ2 of 165°-175°. For example, the included angle δ2 may be 165°, 168°, 172°, or 175°. With this arrangement, it is possible to adapt to the shape of the soft tissue at the back of the wearer's ear and the head portion opposite the back of the wearer's ear, increase the contact area, reduce the pressure, and improve the wearing comfort.

In some embodiments, the connecting line from the first point to the centroid of the first accommodating cavity 210 and the connecting line from the third point to the centroid of the first accommodating cavity 210 form the included angle δ2 of 165°-175° or form the included angle δ2 greater than or equal to 90° and less than 165°. For example, the included angle δ2 may be 90°, 100°, 110°, 120°, 130°, 140°, 150°, 165°, 168°, 172°, or 175°. With this arrangement, it is possible to adapt to the shape of the soft tissue at the back of the wearer's ear and the head portion opposite the back of the wearer's ear, increase the contact area, reduce the pressure, and improve the wearing comfort.

In some embodiments, the first accommodating cavity 210 is a battery cavity, the abutting portion 2 includes a battery, and the battery is accommodated in the battery cavity.

In some embodiments, the ear hook 3 has the ear hook symmetry plane A2 arranged along its length direction, and the ear hook symmetry plane A2 intersects the outermost annular line of the end surface of the first flexible member 213 to form two intersection points. An outer wall of the abutting portion 2 has a third reference point O3, a distance between the third reference point O3 and the outer wall of the sound generation portion 1 is the shortest, and an included angle δ3 formed by lines connecting the third reference point O3 and the two intersection points is between 80° and 130°. For example, the included angle δ3 may be 80°, 90°, 100°, 110°, 120°, or 130°.

In some embodiments, when the earphone 100 is in the natural state (i.e., without external force intervention), on the ear hook symmetry plane A2, the sound generation portion 1 and the abutting portion 2 are arranged apart, and in this situation, the third reference point O3 refers to an endpoint of a shortest connecting line between the sound generation portion 1 and the abutting portion 2 on the abutting portion 2. In some embodiments, when the earphone is in the natural state (i.e., without external force intervention), on the ear hook symmetry plane A2, the sound generation portion 1 and the abutting portion 2 abut against each other, and in this situation, the third reference point O3 refers to a midpoint of an arc segment formed by an abutting area between the sound generation portion 1 and the abutting portion 2 on the ear hook symmetry plane A2.

Setting the included angle of the first flexible member 213 in this way can ensure that a contact area between the human ear and the first housing 21 for most people or the standard head model is covered by the first flexible member 213, thereby ensuring comfort, and also leaving more space for the first rigid housing 211, thereby ensuring that an internal cavity volume is not excessively occupied by the silicone area.

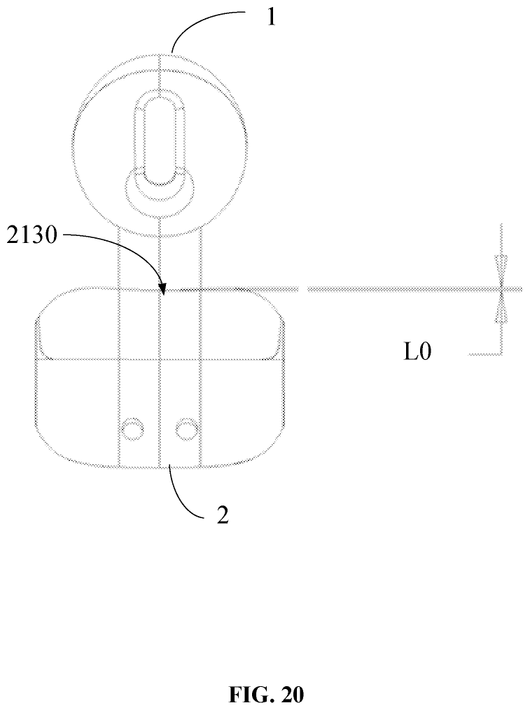

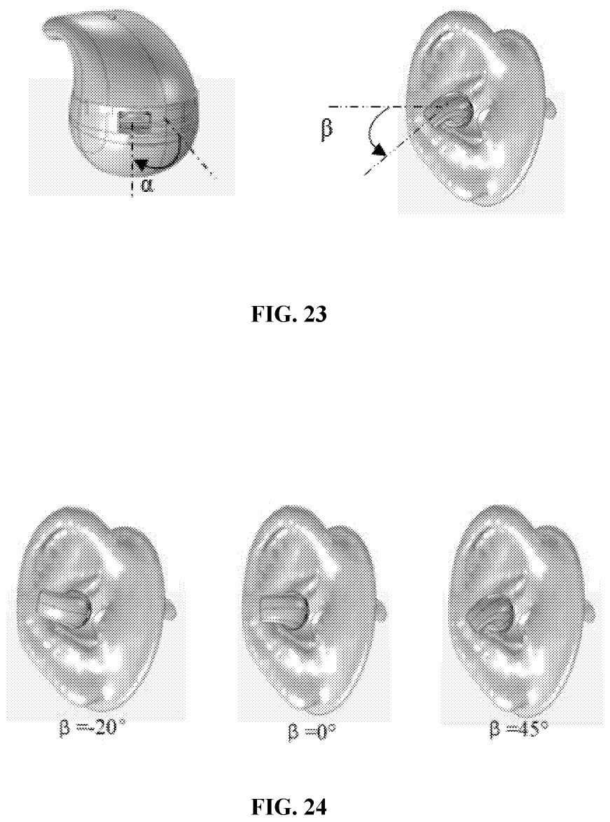

Referring to FIGS. 23-30, it should be noted that angle labels such as α, β, and γ in the following description correspond to angle labels in FIGS. 23-30.

It should be noted that materials of the third flexible member 113 and the first flexible member 213 are not limited to silicone, rubber, elastic resin, polyurethane material, polydimethylsiloxane, PVC, TPE, etc., and any flexible material may be used.

In some embodiments, by changing a position of the sound outlet hole in the sound generation portion, an output volume of the earphone at the ear canal opening of the user may be adjusted. Generally, the greater the output volume of the earphone at the ear canal opening is, the louder the sound the user experiences at the same output power may be, which can reduce power consumption of the earphone and reduce sound leakage.

In some embodiments, as shown in FIG. 23, the second housing 11 is provided with the sound outlet hole 114, and sound generated by the sound generation assembly 12 is output outward through the sound outlet hole 114. The ear hook 3 has the ear hook symmetry plane A2 arranged along its length direction, an included angle α formed between a central axis of the sound outlet hole 114 and the ear hook symmetry plane A2 is between 15° and 45°, and the central axis of the sound outlet hole 114 is located on a lower side of the ear hook symmetry plane A2 in the wearing state. By setting the included angle α formed between the central axis of the sound outlet hole 114 and the ear hook symmetry plane A2 to be between 15° and 45°, the directivity of the sound outlet hole 114 toward the ear hole in the wearing state is better, which is beneficial for improving sound listening effect.

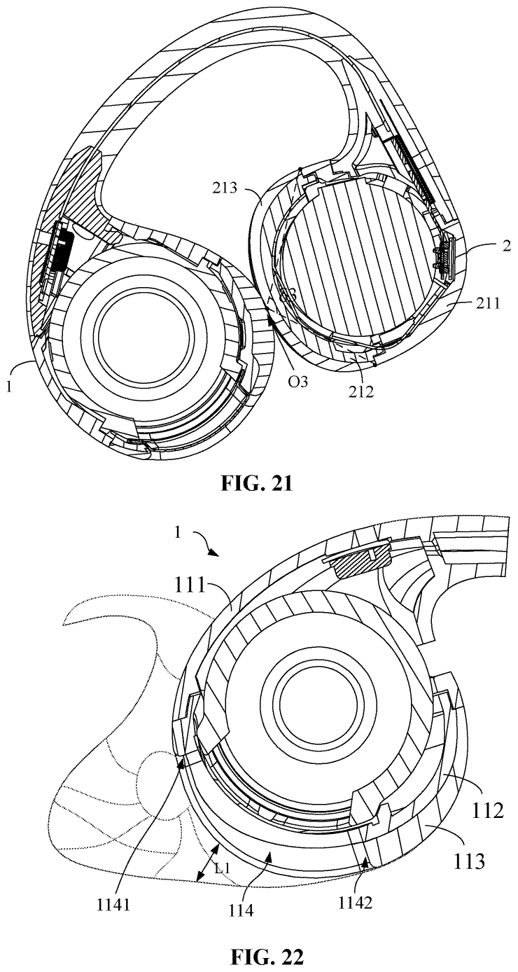

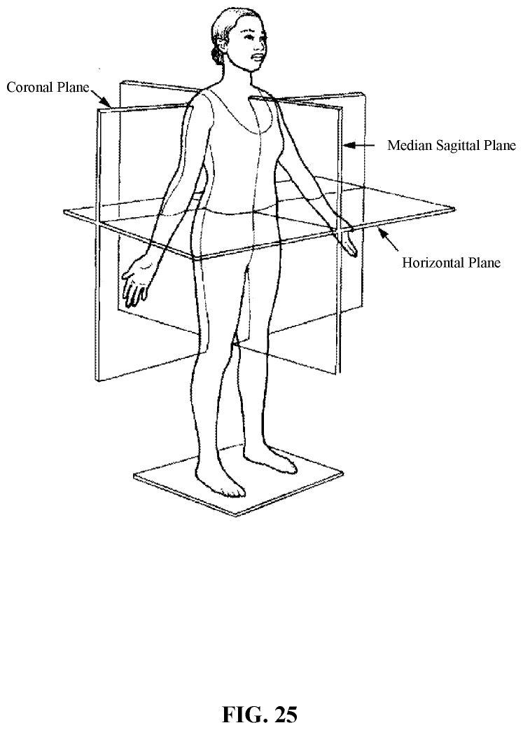

In some embodiments, the sound outlet hole 114 may be a strip shape. Referring to FIG. 23 and FIG. 24, the sound outlet hole is arranged perpendicular to the ear hook symmetry plane (i.e., a long axis of the sound outlet hole is perpendicular or substantially perpendicular to the ear hook symmetry plane, that is, an error within 15° is allowed, which may also be referred to as the sound outlet hole being arranged longitudinally). In this case, the sound outlet hole 114 may be arranged on a portion of the third rigid housing 111 not covered by the third flexible member 113, to avoid the sound outlet hole 114 simultaneously spanning the third rigid housing 111 and the fourth rigid housing 112. An included angle between a normal straight line (the normal straight line refers to the central axis of the sound outlet hole 114) of the sound outlet hole of the earphone pointing outward from the sound generation portion and the ear hook symmetry plane A2 is defined as α, and an included angle between the ear hook symmetry plane A2 and a human body horizontal plane is defined as β. As shown in FIG. 26, with α fixed at 0° (i.e., the ear hook symmetry plane passes through the central axis of the sound outlet hole), and β adjusted to −20°, 0°, and 45°respectively, frequency response curves of the output sound of the earphone at the ear canal opening are obtained, wherein the horizontal coordinate represents an output frequency band (Hz) of the earphone, and the vertical coordinate represents the measured sound pressure level (SPL) (dB).

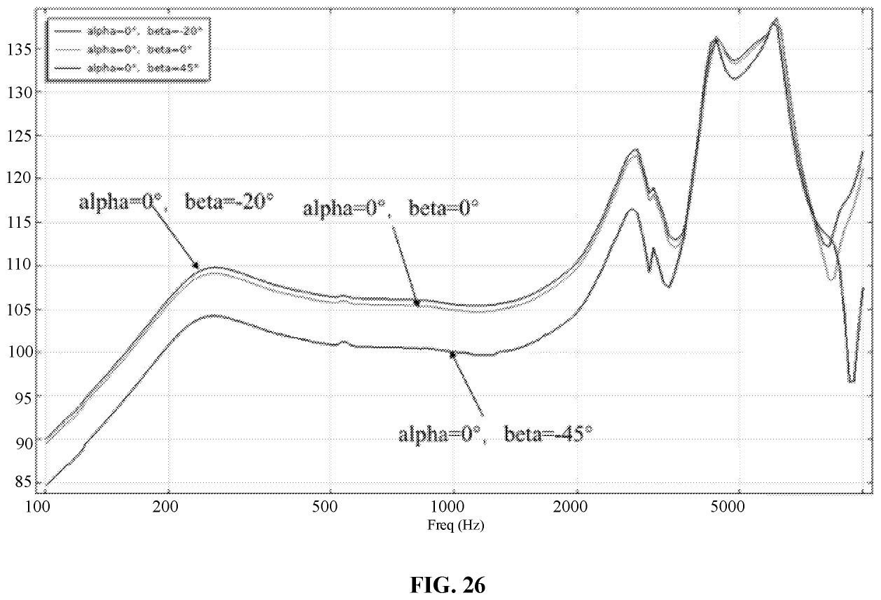

Further, referring to FIG. 27, with β fixed at 0° (i.e., the wearing state where the ear hook symmetry plane is parallel to the human body horizontal plane), and α adjusted to −30°, −15°, 0°, 15°, 30°, 45°, and 60° respectively, frequency response curves of the output sound of the earphone at the ear canal opening are obtained. As shown in FIG. 27, when α is in a range of 15°-45°, the measured sound pressure level (SPL) of the frequency response curve of the earphone is the highest, that is, the output volume is the largest.

In addition, when the clip-on earphone is worn, β is usually between 0° and 30° due to gravity influence. Therefore, setting the sound outlet hole as that when β=0° (i.e., the wearing state where the ear hook symmetry plane is parallel to the human body horizontal plane), the included angle α between the normal straight line of the sound outlet hole (the normal straight line refers to the central axis of the sound outlet hole 114) and the ear hook symmetry plane A2 is in a range of 15°-45°, can increase the listening volume in wearing scenarios where β is between 0° and 30°. (Equivalent to adjusting the line of α=0° and β=45° in xx-2 to be close to a volume of α=0° and β=0°).

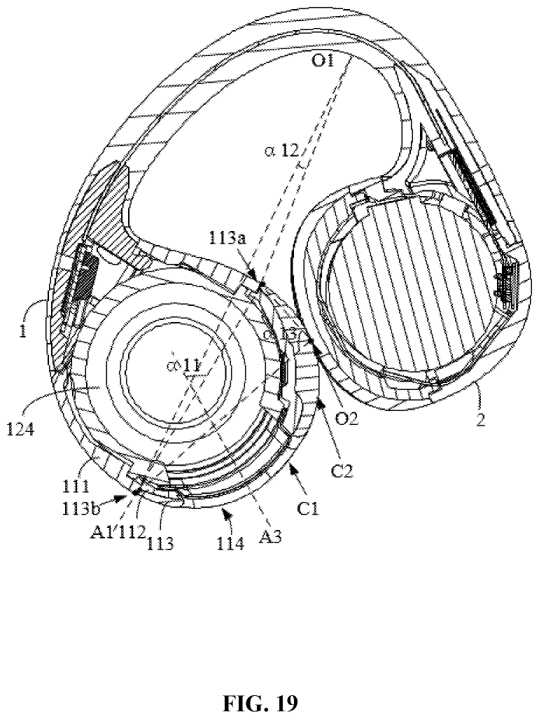

In some embodiments, as shown in FIG. 22, the sound outlet hole 114 is arranged in a strip shape, and has a first end 1141 and a second end 1142 arranged apart along the length direction of the sound outlet hole 114. In the wearing state, the first end 1141 faces the ear hole, and a distance L1 between an outer wall of the second housing 11 at the second end 1142 and an inner wall surface of the concha cavity is less than a distance L1 between an outer wall of the second housing 11 at the first end 1141 and the inner wall surface of the concha cavity.

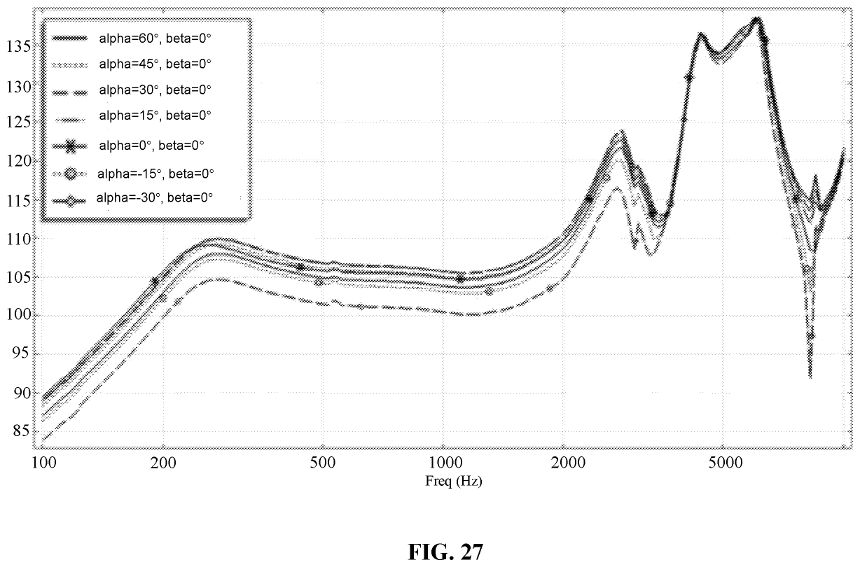

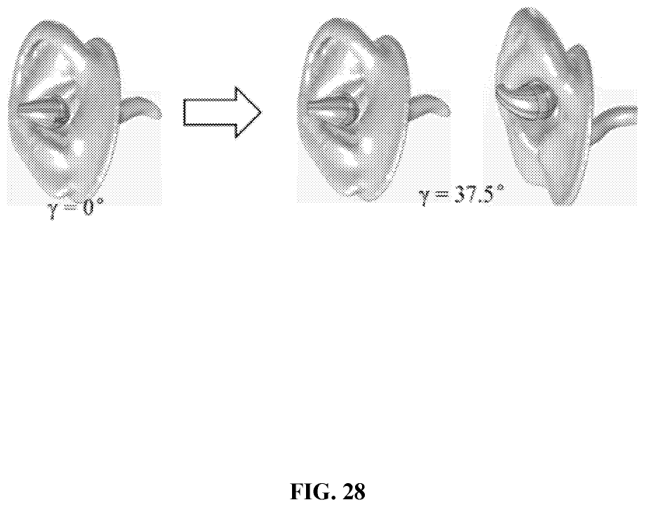

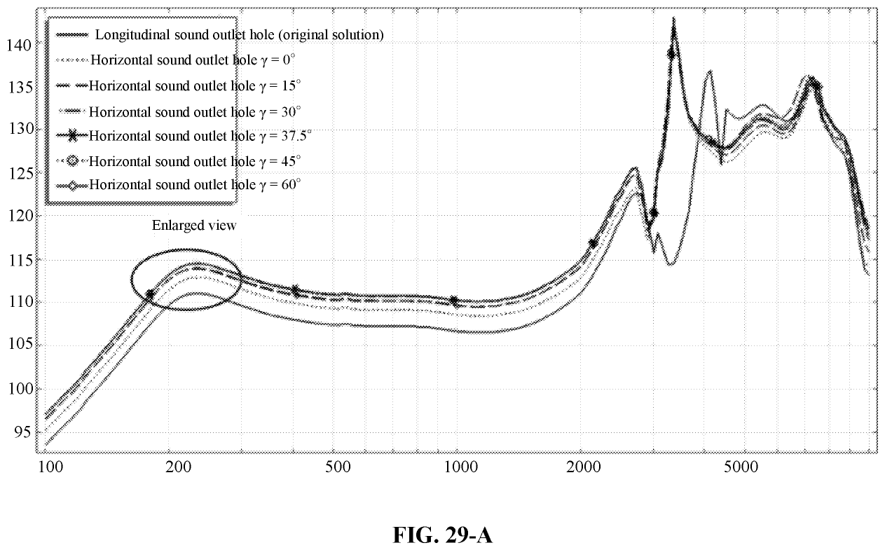

Further, referring to FIG. 28, the sound outlet hole 114 may be arranged horizontally (i.e., the long axis of the sound outlet hole is parallel or substantially parallel to the ear hook symmetry plane, that is, an error within 15° is allowed). In this case, as shown in FIG. 22, the sound outlet hole 114 may be arranged on the fourth rigid housing 112 and the third flexible member 113, to avoid the sound outlet hole 114 simultaneously spanning the third rigid housing 111 and the fourth rigid housing 112. As described above, the longitudinally arranged sound outlet hole is rotated by 90° about its central symmetry axis, and then the normal straight line of the sound outlet hole pointing outward from the sound generation portion is rotated toward a midpoint of a short edge of the sound outlet hole that is closer to the ear canal opening. An angle swept during this rotation process is defined as γ. As shown in FIG. 29, gradients of γ are set as 0°, 15°, 30°, 37.5°, 45°, and 60° respectively, and frequency response curves of the output sound at the ear canal are measured respectively. As shown in FIG. 29, as γ of the sound outlet hole increases (i.e., the sound outlet hole continuously rotates inward toward the ear canal direction), the SPL first increases and then decreases. In a range of 30°-45°, the measured sound pressure level at the ear canal may be considered superior to other segments, and the change in sound pressure level within the range is not significant (the sound pressure level curves for 30°, 37.5°, and 45° are close), that is, the value of γ may be in a range of 30°-45°.

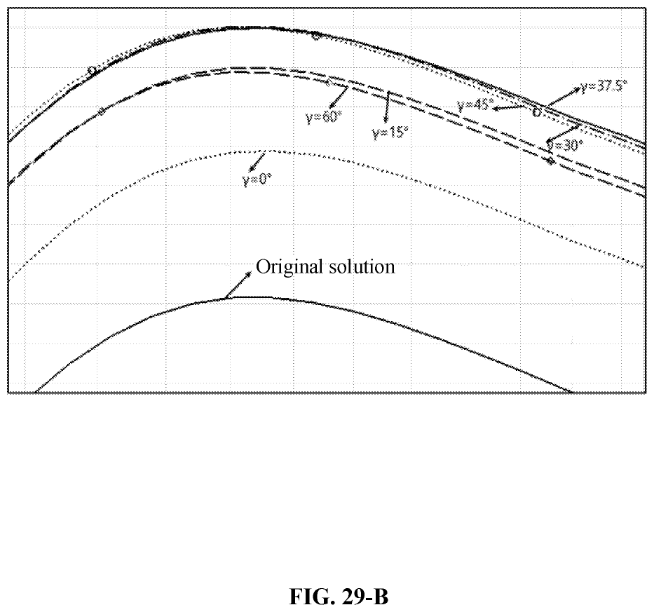

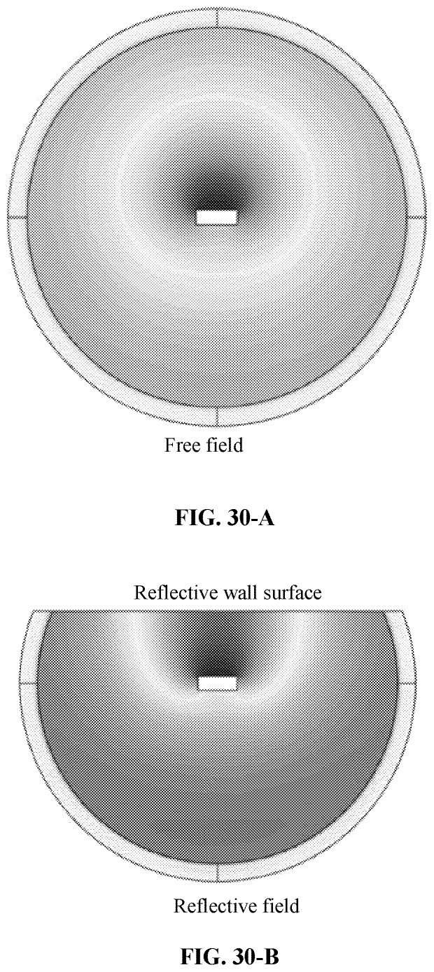

The change trends of the output sound pressure levels (SPL) of the earphone in FIG. 29-A and FIG. 29-B may be explained by the “horn effect”. As shown in FIGS. 30-A and 30-B, the shade of the gray area in the figure represents the magnitude of the sound pressure level. When a point sound source in space radiates sound to the surroundings, if there is a reflective wall surface nearby in the sound propagation direction, compared with a free field, some positions near the sound source in the reflection field will form sound reinforcement areas due to interference and diffraction between the reflected sound wave and the sound source sound wave.

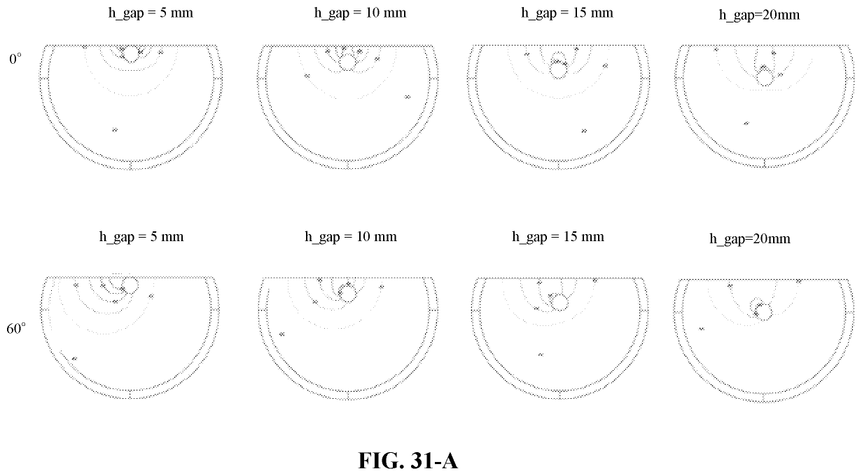

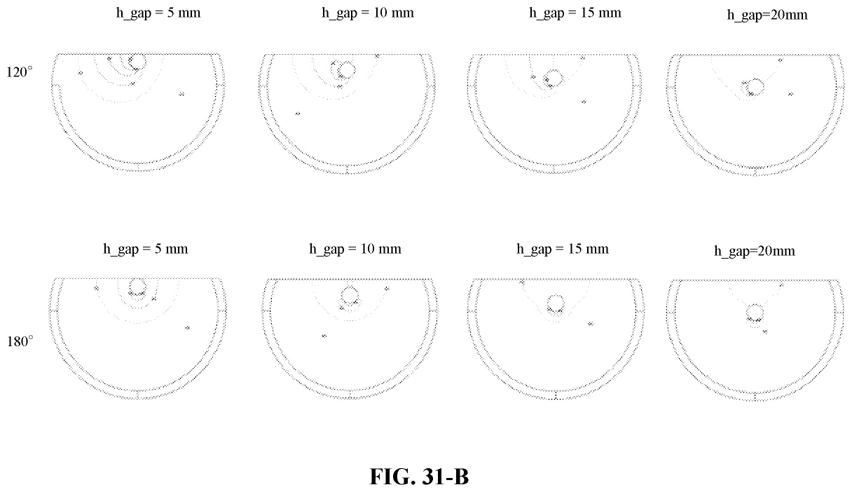

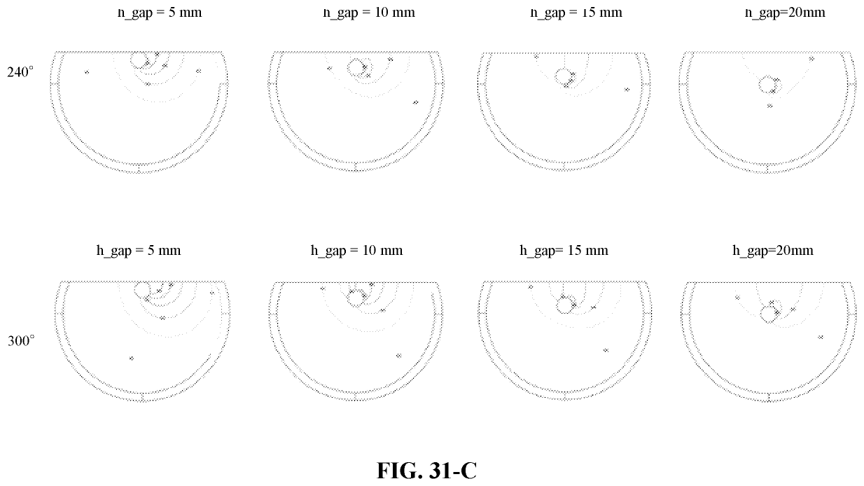

A straight-line distance from a center position of the sound generation portion to the reflective wall surface is defined as h-gap, and an included angle between the normal straight line of the sound outlet hole pointing outward from the sound generation portion and a straight line from the center position of the sound generation portion to the reflective wall surface is defined as θ. FIG. 31A-FIG. 31-C show simulation results when values of h-gap are 5 mm, 10 mm, 15 mm, and 20 mm respectively, values of θ are 0°, 60°, 120°, 180°, 240°, and 300° respectively, and the sound source signal is 2000 Hz, wherein equal sound pressure level line maps are used as the results. The results show that the closer the sound source is to the reflective surface, the louder the sound near the reflective wall surface is, and when the normal straight line of the sound outlet hole pointing outward from the sound generation portion points obliquely toward the reflective wall (60° and 300°), a maximum sound pressure level may be generated on one side (the area of the high sound pressure level region is the largest), and the high sound pressure level region of the side may be regarded as a listening position.

In the present disclosure, the sound generation portion may be considered as a point sound source wrapped by a housing, and a sound outlet hole is opened on the housing, while the concha cavity opposite to the sound outlet hole may be considered as the reflective wall surface. Therefore, when the sound outlet hole abuts against the concha cavity as much as possible and the sound outlet position is located on one side, the listening position at the ear hole may obtain the maximum output sound pressure level.

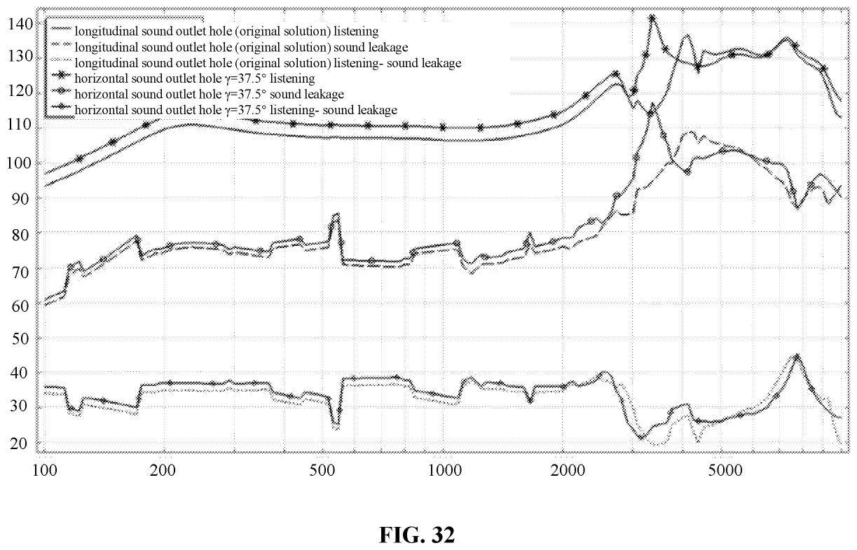

FIG. 32 shows sound leakage curves under different sound outlet hole positions. In the test environment, sound leakage refers to the sound that extends from the ear canal to a point 30 mm away from the ear canal along a direction perpendicular to the sagittal plane of the human body, and this volume may be measured using a microphone. Under optimized conditions, the horizontal sound outlet hole solution (γ=37.5°) reduces sound leakage by approximately 2 dB compared with the original longitudinal sound outlet hole.

The above uses specific examples to illustrate the present disclosure, which are only used to help understand the present disclosure and are not intended to limit the present disclosure. For those skilled in the art of the present disclosure, based on the ideas of the present disclosure, several simple deductions, modifications, or replacements can also be made.

1. A clip-on earphone, comprising:
a sound production portion for inserting into a concha cavity of a wearer;
an abutment portion for abutting against a back of an ear of the wearer; and
an ear hook connecting the sound production portion and the abutment portion, the abutment portion and the sound production portion forming a clamping state to clamp and wear the clip-on earphone on a helix of the wearer, wherein the abutment portion comprises:
a first rigid housing;
a second rigid housing arranged toward the back of the ear of the wearer when the clip-on earphone is worn, wherein the second rigid housing and the first rigid housing enclose to form a first accommodating cavity; and
a first flexible member covering an outer wall of the second rigid housing for contacting the back of the ear of the wearer, wherein an outer wall of the first rigid housing is not covered by the first flexible member and is in an exposed state; or the first flexible member extends from an outer side of the second rigid housing to an outer side of the first rigid housing and covers a portion of the outer wall of the first rigid housing, such that a remaining portion of the outer wall of the first rigid housing is in an exposed state.

2. The clip-on earphone of claim 1, wherein the abutment portion has a strip-shaped structure, wherein
in a cross-section perpendicular to a length direction of the abutment portion, a ratio of a connecting line between two ends of the first flexible member to a maximum radial dimension of the abutment portion is between 0.9 and 1.

3. The clip-on earphone of claim 1, wherein the ear hook has a support rib and a second flexible member, wherein
the second flexible member wraps the support rib; and
the first flexible member and the second flexible member are an integrally formed monolithic structure or are separately arranged.

4. The clip-on earphone of claim 3, wherein the first rigid housing comprises a connecting wall and two side walls, wherein
the two side walls are disposed at opposite ends of the connecting wall;
the second rigid housing is located between the two side walls; and
the connecting wall of the first rigid housing and the second rigid housing are spliced to form an annular peripheral wall of the abutment portion.

5. The clip-on earphone of claim 4, wherein
at least one of the side walls serves as a mounting base; and
an antenna and/or a touch circuit board are mounted on the mounting base.

6. The clip-on earphone of claim 3, wherein
both the first rigid housing and the second rigid housing have a connecting wall and side walls; and
the connecting wall of the first rigid housing and the connecting wall of the second rigid housing are spliced to form an annular peripheral wall of the abutment portion.

7. The clip-on earphone of claim 6, wherein
the side walls of the first rigid housing and the side walls of the second rigid housing are spliced to form a mounting base; and
an antenna and/or a touch circuit board are mounted on the mounting base.

8. The clip-on earphone of claim 6, wherein
at least one of the side walls of the first rigid housing or the side walls of the second rigid housing serves as a mounting base; and
an antenna and/or a touch circuit board are mounted on the mounting base.

9. The clip-on earphone of claim 1, wherein
an outer wall of the first flexible member includes a concave surface arranged toward the sound production portion; and
the sound production portion contacts at least a portion of the concave surface in a natural state.

10. The clip-on earphone of claim 9, wherein
the abutment portion has a strip-shaped structure; and
in a cross-section perpendicular to a length direction of the abutment portion, a depth of the concave surface is between 0.07 and 0.25.

11. The clip-on earphone of claim 9, wherein
the abutment portion has a strip-shaped structure; and
in a cross-section perpendicular to a length direction of the abutment portion and passing through a midpoint of the length direction, the concave surface is recessed toward an interior of the abutment portion.

12. The clip-on earphone of claim 9, wherein
the abutment portion has a strip-shaped structure; and
in a cross-section perpendicular to a length direction of the abutment portion and passing through a midpoint of the length direction, the first flexible member has a shape that is thin in middle and thick at both ends.

13. The clip-on earphone of claim 1, wherein
the abutment portion has a strip-shaped structure; and
in a cross-section perpendicular to a length direction of the abutment portion, an included angle between connecting lines from a centroid of the first accommodating cavity to two endpoints of an outer contour line of the first flexible member is greater than or equal to 160°, or is greater than or equal to 145° and less than 160°.

14. The clip-on earphone of claim 1, wherein
the abutment portion has a strip-shaped structure; and
in a cross-section perpendicular to a length direction of the abutment portion, an arc length of an outer contour line of the first flexible member is greater than or equal to 18 mm, or is greater than or equal to 12 mm and less than 18 mm.

15. The clip-on earphone of claim 1, wherein
the abutment portion has a strip-shaped structure; and
in a cross-section perpendicular to a length direction of the abutment portion, an outer wall of the first flexible member has a first point, a second point, and a third point distributed sequentially along an arc length thereof, and a distance from the first point to a centroid of the first accommodating cavity and a distance from the third point to the centroid of the first accommodating cavity are both greater than a distance from the second point to the centroid of the first accommodating cavity.

16. The clip-on earphone of claim 15, wherein the second point is located at a midpoint of the outer wall of the first flexible member.

17. The clip-on earphone of claim 15, wherein an included angle between a connecting line from the first point to the centroid of the first accommodating cavity and a connecting line from the second point to the centroid of the first accommodating cavity is equal to an included angle between the connecting line from the second point to the centroid of the first accommodating cavity and a connecting line from the third point to the centroid of the first accommodating cavity.

18. The clip-on earphone of claim 15, wherein a distance from the first point to the centroid of the first accommodating cavity is equal to a distance from the third point to the centroid of the first accommodating cavity.

19. The clip-on earphone of claim 15, wherein
a difference between a thickness of the first flexible member at the first point and a thickness of the first flexible member at the second point is between 0.2 mm and 0.5 mm, or is less than or equal to 0.2; and/or
a difference between a thickness of the first flexible member at the third point and the thickness of the first flexible member at the second point is between 0.2 mm and 0.5 mm, or is less than or equal to 0.2.

20. The clip-on earphone of claim 19, wherein
the thickness of the first flexible member at the first point is between 1.4 mm and 1.7 mm, or is greater than or equal to 0.3 mm and less than or equal to 1.4 mm; and/or
the thickness of the first flexible member at the second point is between 1.0 mm and 1.3 mm, or is greater than or equal to 0.2 mm and less than or equal to 1.3 mm; and/or
the thickness of the first flexible member at the third point is between 1.4 mm and 1.7 mm, or is greater than or equal to 0.3 mm and less than or equal to 1.4 mm.

21-23. (canceled)
